(19) United States
(12) Patent Application Publication
(10) Pub. No.: US 2016/0327073 A1
(43) Pub. Date: Nov. 10, 2016

(54) DYNAMICALLY CONTROLLABLE FORCE-GENERATING SYSTEM

(71) Applicant: STABILIS INC., Los Angeles, CA (US)

(72) Inventors: Faisal Amlani, Pasadena, CA (US); Manuel Lombardini, Pasadena, CA (US); Jonathan Miller, Pasadena, CA (US)

(21) Appl. No.: 14/706,823

(22) Filed: May 7, 2015

(51) Int. Cl. F15D 1/00

(52) U.S. Cl. CPC F15D 1/007

(57) ABSTRACT

A dynamically controllable force-generating device configured to be incorporated into a vehicle, such as an aircraft or a ship, or an energy-harvesting device, such as a wind turbine, is disclosed. The dynamically controllable force-generating device includes a force-generating motive surface, a motor operatively coupled to the force-generating motive surface to move at least a portion of the force-generating motive surface to generate a force, at least one controlling motive surface spaced apart from the force-generating motive surface, and a motor operatively coupled to the at least one controlling motive surface to move at least a portion of the controlling motive surface to change at least one of a direction and a magnitude of the force generated by the force-generating motive surface.

### FIELD

The present disclosure relates generally to force-generating devices and, more particularly, to dynamically controllable force-generating devices.

### BACKGROUND

It is a well-known fluid dynamic phenomenon that a rotating body in a fluid flow-stream (e.g., air or water) will, under particular conditions, generate a force transverse to the direction of the fluid flow stream (e.g., lift). For instance, the Magnus effect refers to the observable phenomenon that the trajectory of a rotating sphere or an ogive cylinder (e.g., baseballs or ballistic munitions) will have a curved flight trajectory due to the transverse force acting on the rotating body. This aerodynamic phenomenon thus creates the possibility that rotating bodies may be incorporated into a vehicle (e.g., an aircraft, a ship, or an automobile) to generate lift and/or thrust to propel the vehicle.

However, conventional rotating bodies generate a highly complex and unstable wake aft of the rotating body, which results in large oscillations in the magnitude and direction of the resultant force generated by the rotating body. Additionally, the wake generated by conventional rotating bodies produces a large magnitude force parallel to the direction of the free-stream (i.e., drag), which retards forward motion of the rotating body. These complexities and fluid dynamic disadvantages, compounded with the mechanical challenges of implementation, have rendered conventional motive surfaces impractical as force-altering devices for aircraft and other vehicles. Accordingly, conventional vehicles typically incorporate passive, non-motive bodies to generate lift and/or thrust. For instance, conventional aircraft incorporate fixed wings, rather than rotating bodies, due to the relative simplicity and predictability of airflow around airfoils.

### SUMMARY

The present disclosure is directed to various embodiments of a dynamically controllable force-generating device configured to be incorporated into a vehicle, such as an aircraft (e.g., a helicopter), a ship, or an automobile, or an energy-harvesting device, such as a wind turbine. In one embodiment, the dynamically controllable force-generating device includes a force-generating motive surface, a motor operatively coupled to the force-generating motive surface to move at least a portion of the force-generating motive surface to generate a force, at least one controlling motive surface spaced apart from the force-generating motive surface, and a motor operatively coupled to the at least one controlling motive surface to move at least a portion of the controlling motive surface to change at least one of a direction and a magnitude of the force generated by the force-generating motive surface. The force-generating motive surface may have a different size than the controlling motive surface (e.g., the force-generating motive surface may be larger than the controlling motive surface) or the force-generating motive surface may have substantially the same size as the controlling motive surface. The force-generating motive surface and the controlling motive surface may each have a shape of revolution, such as a cylinder, a cone, a paraboloid, an ellipsoid, a hyperboloid, or a portion thereof. Only a portion of the force-generating motive surface and/or only a portion of the controlling motive surface may be configured to move. The force-generating motive surface and the controlling motive surface may be arranged inline, side-by-side, or may be staggered.

The dynamically controllable force-generating device may also include a second motor coupled to the controlling motive surface. The second motor is configured to move the controlling motive surface between a first position spaced apart from the force-generating motive surface by a first distance and a second position spaced apart from the force-generating motive surface by a second distance different than the first distance. The dynamically controllable force-generating device may include a series of controlling motive surfaces and each of the controlling motive surfaces may be independently actuatable between a first position spaced apart from the force-generating motive surface by a first distance and a second position spaced apart from the force-generating motive surface by a second distance different than the first distance. The dynamically controllable force-generating device may also include a second motor coupled to the controlling motive surface. The second motor is configured to move the controlling motive surface around the force-generating motive surface between a first position and a second position different than the first position. The dynamically controllable force-generating device may also include an endplate assembly coupled to a first end of each of the force-generating motive surface and the controlling motive surface. The endplate assembly may define at least one track slidably supporting the first end of the controlling motive surface. The controlling motive surface may be configured to move laterally along an axis defined by the controlling motive surface. The dynamically controllable force-generating device may also include a shroud disposed between the force-generating motive surface and the controlling motive surface. The shroud is configured to move between a retracted position and a deployed position.

The present disclosure is also directed to various methods of dynamically altering fluid dynamic properties of a force-generating device including a force-generating motive surface and at least one controlling motive surface spaced apart from the force-generating motive surface. In one embodiment, the method includes introducing the force-generating device into a fluid flow having a free-stream velocity, moving at least a portion of the force-generating motive surface at a first surface speed, and changing the controlling motive surface from a first state to a second state. The force-generating motive surface generates a first resultant force having a first direction and a first magnitude when the controlling motive surface is in the first state, the force-generating motive surface generates a second resultant force having a second direction and a second magnitude when the controlling motive surface is in the second state, and at least one of the second direction and the second magnitude is different than a corresponding one of the first direction and the first magnitude. Changing the controlling motive surface from the first state to the second state may include moving the controlling motive surface from a first position spaced apart from the force-generating motive surface by a first distance to a second position spaced apart from the force-generating motive surface by a second distance different than the first distance. The second position may alter a boundary layer formed around the force-generating motive surface by a first extent and the first position may alter the boundary layer by a second extent different than the first extent. Changing the controlling motive surface from the first state to the second state may include accelerating or decelerating the controlling motive surface from a first surface speed to a second surface speed different than the first surface speed. Changing the controlling motive surface from the first state to the second state may include moving the controlling motive surface around the force-generating motive surface from a first angular position to a second angular position. Changing the controlling motive surface from the first state to the second state may include moving a shroud between a retracted position and a deployed position. The method may also include accelerating or decelerating the force-generating motive surface to a second surface speed different than the first surface speed. The method may further include moving the controlling motive surface laterally along an axis of the controlling motive surface.

This summary is provided to introduce a selection of concepts that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a perspective view of a dynamically controllable lifting device according to one embodiment of the present disclosure;

FIG. 2 is a side view of the embodiment of the dynamically controllable lifting device illustrated in FIG. 1;

FIG. 3A is a cutaway perspective view of the embodiment of the dynamically controllable lifting device illustrated in FIG. 1;

FIGS. 3B and 3C are enlarged detail views of the cutaway perspective view illustrated in FIG. 3A

FIG. 4A is a cross-sectional view of the embodiment of the dynamically controllable lifting device illustrated in FIG. 1;

FIGS. 4B and 4C are enlarged detail views of the cross-sectional view illustrated in FIG. 4A;

FIG. 5 is a two-dimensional diagrammatic view of fluid flow around the embodiment of the dynamically controllable lifting device illustrated in FIG. 1 in a first configuration;

FIG. 6 is a two-dimensional diagrammatic view of fluid flow around the embodiment of the dynamically controllable lifting device illustrated in FIG. 1 in a second configuration;

FIG. 7A is a perspective view of a dynamically controllable lifting device according to another embodiment of the present disclosure incorporated into a wing;

FIG. 7B is a perspective view of the dynamically controllable lifting device and the wing illustrated in FIG. 7A with a skin of the wing removed to reveal internal components of the wing and the dynamically controllable lifting device;

FIG. 7C is a cross-section of the dynamically controllable lifting device and the wing illustrated in FIG. 7A;

FIG. 7D is an enlarged detail view of a portion of the cross-section illustrated in FIG. 7C;

FIG. 8A is a two-dimensional diagrammatic view of fluid flow around the wing and the embodiment of the dynamically controllable lifting device illustrated in FIG. 7A when a force-generating motive surface and a controlling-motive surface are deactivated, and a shroud is in a retracted position;

FIG. 8B is a two-dimensional diagrammatic view of fluid flow around the wing and the embodiment of the dynamically controllable lifting device illustrated in FIG. 7A when the force-generating motive surface is activated, the controlling-motive surface is deactivated, and the shroud is in the retracted position;

FIG. 8C is a two-dimensional diagrammatic view of fluid flow around the wing and the embodiment of the dynamically controllable lifting device illustrated in FIG. 7A when the force-generating motive surface is activated, the controlling-motive surface is activated, and the shroud is in the retracted position;

FIG. 8D is a two-dimensional diagrammatic view of fluid flow around the wing and the embodiment of the dynamically controllable lifting device illustrated in FIG. 7A when the force-generating motive surface is activated, the controlling-motive surface is activated, and the shroud is in a deployed position; and

FIG. 9 is a perspective view of fluid flow around the wing and the embodiment of the dynamically controllable lifting device in FIG. 7A when an inboard shroud is in a deployed position and an outboard shroud is in a retracted position.

### DETAILED DESCRIPTION

The present disclosure is directed to various embodiments of a dynamically controllable force-generating device having a force-generating motive body (e.g., a primary body) and at least one controlling motive body (e.g., at least one auxiliary body). Rotation of the force-generating motive body is configured to generate a resultant force (e.g., lift) when a fluid (e.g., air or water) flows over the force-generating motive body. The one or more controlling motive bodies of the present disclosure are configured to modify the aerodynamic characteristics of the fluid flowing around the force-generating motive body and thereby increase the resultant force (e.g., lift) and/or reduce drag generated by the force-generating motive body (e.g., the one or more controlling motive bodies are configured to vector the resultant force generated by the force-generating motive body). The rotation rate and/or the position of the one or more controlling motive bodies relative to the force-generating motive body may be changed to modify the aerodynamic characteristics of the fluid flowing around the force-generating motive body. The dynamically controllable force-generating devices of the present disclosure may be incorporated into suitable vehicle (e.g., an automobile, a sea vessel, or an aircraft, such as a drone, a commercial transport airplane, a cargo plane, or a helicopter) or an energy-harvesting device (e.g., a wind turbine). The dynamically controllable force-generating devices of the present disclosure may also be configured to generate a net positive energy benefit because the energy required to rotate the force-generating motive body (e.g., the primary body) and the one or more controlling motive bodies (e.g., the auxiliary bodies) and to change the position of the one or more controlling motive bodies (e.g., changing the radial and/or azimuthal positions of the one or more auxiliary motive bodies relative to the force-generating motive body), described in detail below, is less than the energy saved by improving the aerodynamic characteristics of the fluid flowing around the force-generating motive body.

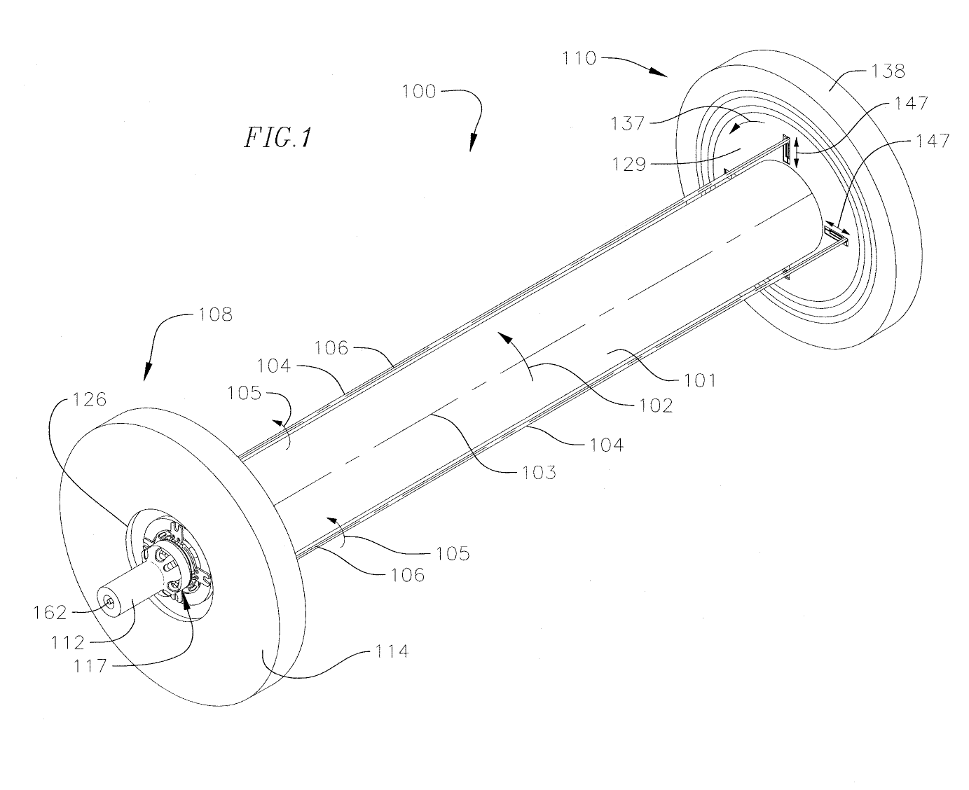

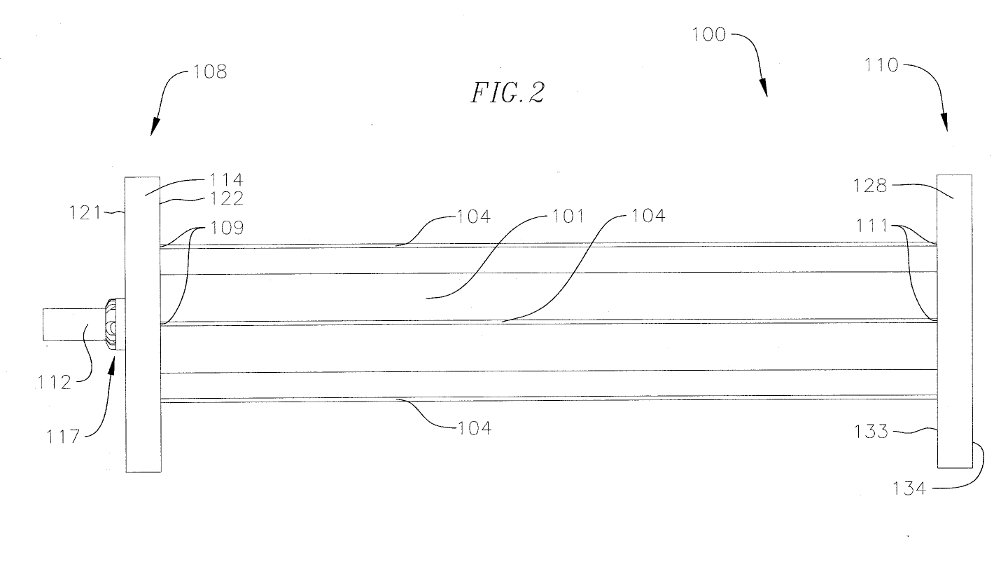

With reference now to FIGS. 1 and 2, a dynamically controllable force-generating device 100 according to one embodiment of the present disclosure includes a primary motive body 101 (e.g., a Magnus rotor) configured to rotate (arrow 102) about its longitudinal axis 103 and at least one auxiliary motive body 104 spaced apart from the primary motive body 101. Although in the illustrated embodiment the dynamically controllable force-generating device 100 includes four auxiliary motive bodies 104 disposed around the primary motive body 101, in one or more alternate embodiments, the dynamically controllable force-generating device 100 may include any other suitable number of auxiliary motive bodies 104, such as, for instance, from one to six auxiliary motive bodies 104 disposed around the primary motive body 101. Additionally, although in the illustrated embodiment, the auxiliary motive bodies 104 are equidistantly or uniformly spaced around the primary motive body 101 (e.g., by approximately 90 degrees azimuthally), in one or more alternate embodiments, the auxiliary motive bodies 104 may be non-uniformly spaced around the primary motive body 101. Further, any suitable angle may be defined between adjacent auxiliary motive bodies 104, such as, for instance, from approximately 15 degrees to approximately 180 degrees.

Each of the auxiliary motive bodies 104 is configured to rotate (arrow 105) around a longitudinal axis 106 defined by the respective auxiliary motive body 104. As described in more detail below, rotation (arrow 102) of the primary motive body 101 about its longitudinal axis 103 is configured to generate a force (e.g., lift) and the rotation (arrow 105) of the auxiliary motive bodies 104 is configured to improve the aerodynamic properties of fluid (e.g., air or water) flowing around the primary motive body 101 (e.g., the auxiliary motive bodies 104 may be configured to reduce drag and increase lift generated by the primary motive body 101).

In the illustrated embodiment, the primary motive body 101 is a cylindrical tube, although in one or more alternate embodiments, the primary motive body 101 may have any other desired shape suitable for generating a force (e.g., lift) when rotating, such as, for instance, an airfoil shape. In one or more embodiments, at least a portion of the primary motive body 101 may be a shape of revolution, such as, for instance, a cylinder, a cone, a paraboloid, an ellipsoid, a hyperboloid, or any portion or combination thereof. In one or more embodiments, at least a portion of the primary motive body 101 may have a shape formed by revolving a line (e.g., a sinusoidal line) around an axis of symmetry. Additionally, although in the illustrated embodiment the entire primary motive body 101 is configured to rotate (arrow 102), in one or more alternate embodiments, only a portion or portions of the primary motive body 101 may be configured to rotate (arrow 102) about the longitudinal axis 103. For instance, in one embodiment, opposite ends of the primary motive body 101 may be stationary and a central portion of the primary motive body 101 may be configured to rotate about the longitudinal axis 103. Similarly, in one or more alternate embodiments, only a portion or portions of one or more of the auxiliary motive bodies 104 may be configured to rotate (arrow 105) about the respective longitudinal axis 106 of the auxiliary motive body 104. Additionally, although the auxiliary motive bodies 104 in the illustrated embodiment are cylindrical, in one or more alternate embodiments, the auxiliary motive bodies 104 may have any other suitable shapes. For example, in one embodiment, at least a portion of the auxiliary motive bodies 104 may be a shape of revolution, such as, for instance, a cylinder, a cone, a paraboloid, an ellipsoid, a hyperboloid, or any portion or combination thereof. In one or more embodiments, at least a portion of the auxiliary motive bodies 104 may have a shape formed by revolving a line (e.g., a sinusoidal line) around an axis of symmetry.

The primary and auxiliary motive bodies 101, 104 may have any desired sizes suitable for the intended application of the dynamically controllable force-generating device 100. For instance, in one or more embodiments, the ratio of the diameter of the auxiliary motive bodies 104 to the diameter of the primary motive body 101 ranges from approximately 1/10 to approximately 1/30. In one embodiment, the ratio of the diameter of the auxiliary motive bodies 104 to the diameter of the primary motive body 101 is approximately 1/20. Additionally, the primary and auxiliary motive bodies 101, 104 may have any desired length suitable for the intended application of the dynamically controllable lifting device 100. For instance, in one or more embodiments, the primary motive body 101 has a length to diameter aspect ratio from approximately 4:1 to approximately 12:1, such as, for instance, approximately 8:1. In one or more embodiments, the auxiliary motive bodies 104 may be the same or substantially the same size as the primary motive body 101. These values listed for the sizes (e.g., length and diameter) of the primary motive body 101 and the auxiliary motive body 104 are simply exemplary and will change, depending, for instance, on the design, scale, and application of the dynamically controllable lifting device 100.

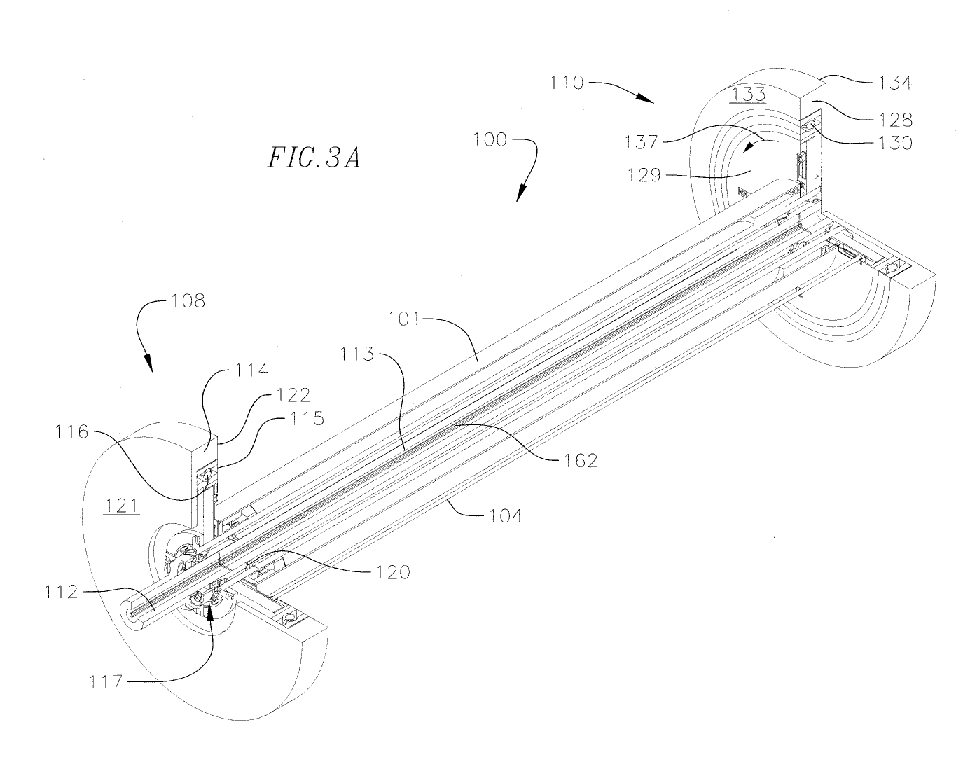

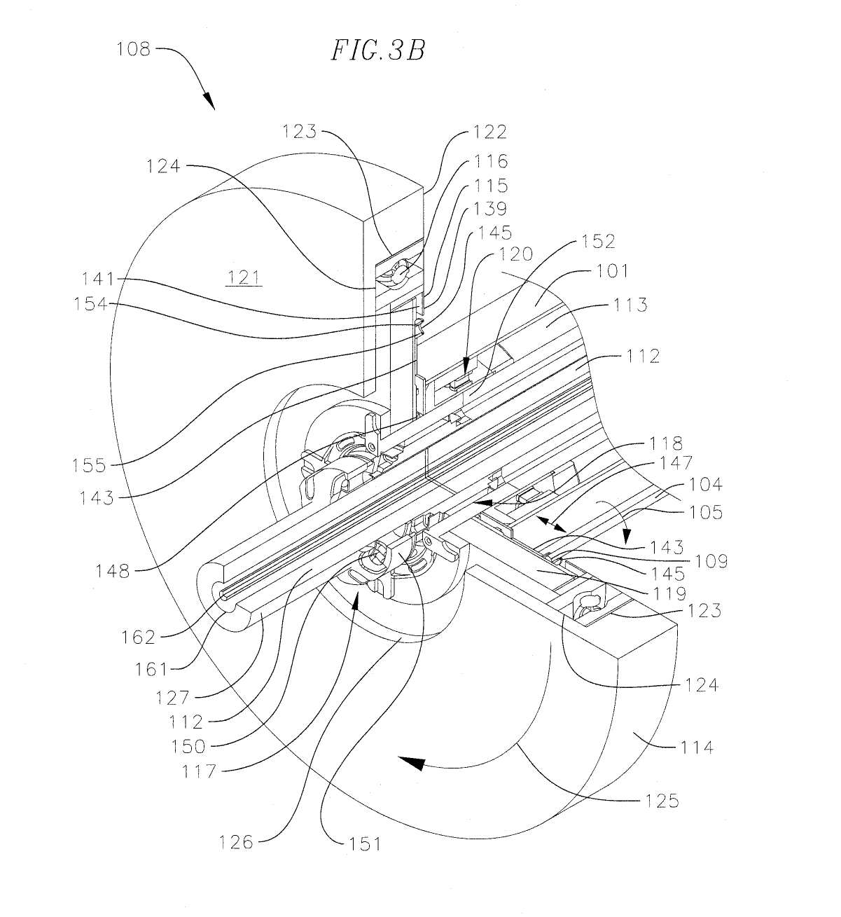

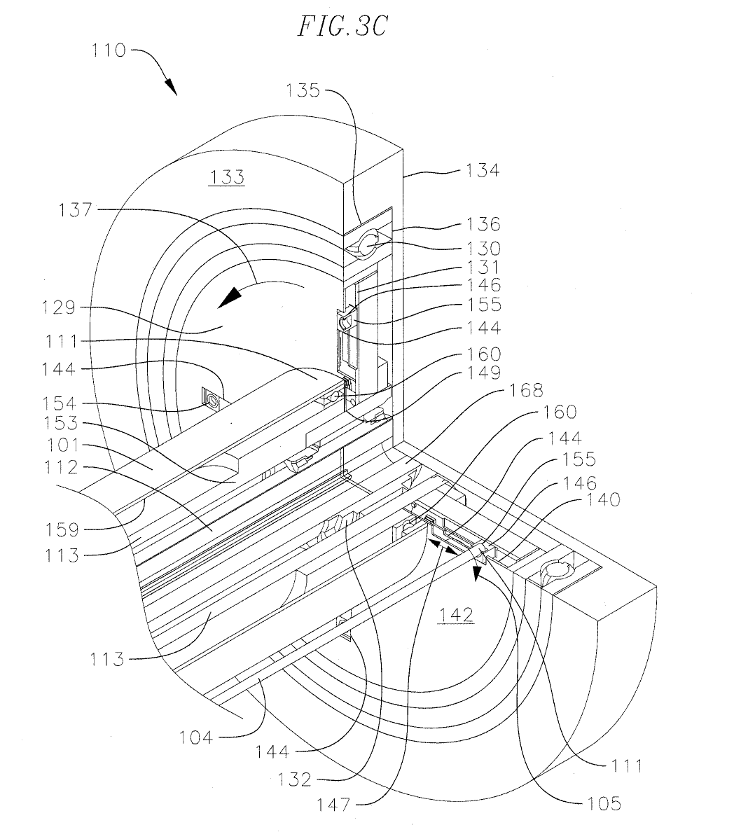

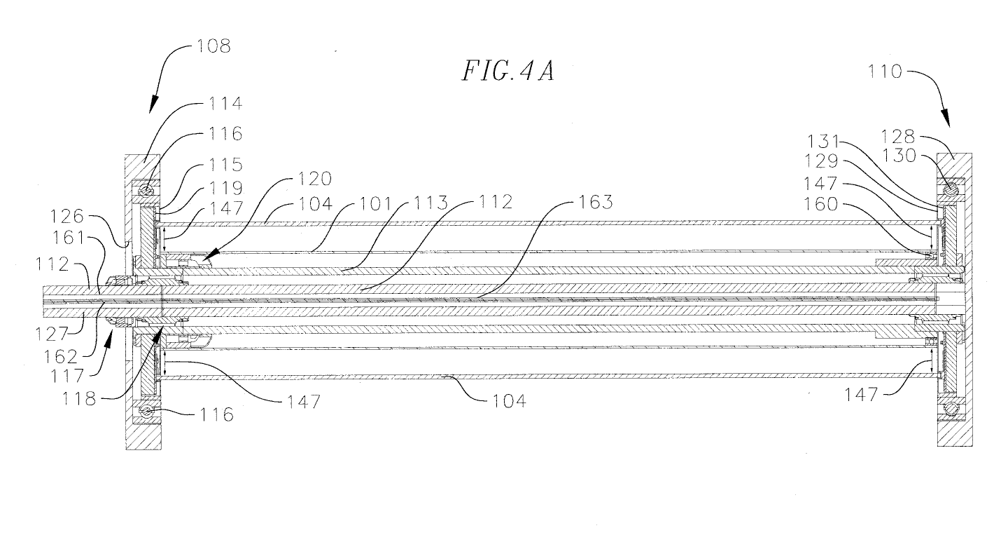

With reference now to the embodiment illustrated in FIGS. 3A and 4A, the dynamically controllable lifting device 100 includes a master endplate assembly 108 coupled to an inboard end 109 of each of the primary and auxiliary motive bodies 101, 104 and a slave endplate assembly 110 coupled to an outboard end 111 of each of the primary and auxiliary motive bodies 101, 104. As described in detail below, the master endplate assembly 108 houses drive motors configured to rotate (arrows 102, 105) the primary and auxiliary motive bodies 101, 104 about their longitudinal axes 103, 106, respectively, and to radially and azimuthally position the one or more auxiliary motive bodies 104 around the primary motive body 101. The slave endplate assembly 110 is configured to support the outboard ends 111 of the primary and auxiliary motive bodies 101, 104.

As illustrated in FIGS. 3A and 4A, the dynamically controllable force-generating 100 device also includes a fixed support strut 112 and a rotary plate drive shaft 113 extending between the master endplate assembly 108 and the slave endplate assembly 110. In the illustrated embodiment, the rotary plate drive shaft 113 is concentrically nested in the primary motive body 101 and the support strut 112 is concentrically nested in the rotary plate drive shaft 113. Additionally, in the illustrated embodiment, the support strut 112 and the rotate plate drive shaft 113 are cylindrical tubes, although in one or more alternate embodiments, the support strut 112 and the rotate plate drive shaft 113 may have any other suitable shapes. The significance of the fixed support strut 112 and the rotary plate drive shaft 113 are described in detail below.

With reference now to the embodiment illustrated in FIG. 3B, the master endplate assembly 108 includes a master endplate housing 114, a master rotary plate 115, a rotary plate bearing 116, a rotary plate drive motor 117, a master slipring assembly 118, a printed circuit board (PCB) 119, and a primary motor 120. The master endplate housing 114 is configured to be fixedly coupled to another component of the device, such as, for instance, a vehicle (e.g., a ship, an automobile, or an aircraft) or an energy-harvesting device (e.g., a wind turbine), into which the dynamically controllable force-generating device 100 is incorporated. Additionally, in the illustrated embodiment, the master endplate housing 114 is a disk having an inner surface 121 and an outer surface 122 opposite the inner surface 121. Although in the illustrated embodiment the master endplate housing 114 is cylindrical, in one or more alternate embodiments, the master endplate housing 114 may have any other suitable shape. The master endplate housing 114 also defines a recess 123 (e.g., a circular blind bore) in the outer surface 122 (i.e., the recess 123 extends inward from the outer surface 122 toward the inner surface 121). The recess 123 in the master endplate housing 114 defines a shoulder 124 configured to support the rotary plate bearing 116 (e.g., the rotary plate bearing 116 extends around a periphery of the recess 123 in the master endplate housing 114 and abuts against the shoulder 124). The master rotary plate 115 is rotatably supported by the rotary plate bearing 116 such that the master rotary plate 115 is configured to rotate (arrow 125) relative to the fixed master endplate housing 114, the significance of which is described below.

The master endplate assembly 108 also includes an opening 126 (e.g., a circular hole) extending through the master endplate housing 114. In the embodiment illustrated in FIG. 3B, an inboard end 127 of the fixed support strut 112 extends through the opening 126 defined in the master endplate housing 114 of the master endplate assembly 108 (i.e., the fixed support strut 112 extends inboard beyond the master endplate assembly 108). The portion of the fixed support strut 112 extending beyond the master endplate assembly 108 facilitates mechanical attachment of the dynamically controllable lifting device 100 to another structure, such as, for instance, a hub of a wind turbine, a hub of a helicopter rotor, a fuselage of an aircraft, or a hull of a ship.

With reference now to the embodiment illustrated in FIG. 3C, the slave endplate assembly 110 includes a slave endplate housing 128, a slave rotary plate 129, a rotary plate bearing 130, a PCB 131, and a slave slipring assembly 132. In the illustrated embodiment, the slave endplate housing 128 is a disk having an inner surface 133 and an outer surface 134 opposite the inner surface 133. Although in the illustrated embodiment the slave endplate housing 128 is cylindrical, in one or more alternate embodiments, the slave endplate housing 128 may have any other suitable shape. The slave endplate housing 128 also defines a recess 135 (e.g., a blind bore) in the inner surface 133 that defines a shoulder 136 configured to support the rotary plate bearing 130. The rotary plate bearing 130 is received in the recess 135 in the slave endplate housing 128, extends around a periphery of the recess 135, and abuts against the shoulder 136. The slave rotary plate 129 is rotatably supported by the rotary plate bearing 130 such that the slave rotary plate 129 is configured to rotate (arrow 137) relative to the fixed slave endplate housing 128. Additionally, the slave endplate housing 128 is fixedly coupled to an outboard end 138 of the fixed support strut 112 such that the slave endplate housing 128 is configured not to rotate.

The master and slave endplate housings 114, 128 may have any size suitable for the intended application of the dynamically controllable lifting device 100. For instance, in one or more embodiments, a ratio of the diameter of the master and slave endplates housings 114, 128 to the primary motive body 101 is from approximately 2:1 to approximately 4:1, such as, for instance, approximately 3:1. Additionally, although in the illustrated embodiment the master and slave endplate housings 114, 128 each have the same or substantially the same size, in one or more alternate embodiments, the master and slave endplate housings 114, 128 may have different sizes.

With continued reference to the embodiment illustrated in FIGS. 3B and 3C, the master and slave rotary plates 115, 129 of the master and slave endplate assemblies 108, 110, respectively, are thin circular plates (i.e., discs) each having an outer surface 139, 140 and an inner surface 141, 142 opposite the outer surface 139, 140, respectively. Additionally, in the illustrated embodiment, four channels or tracks 143, 144 are defined in each of the master and slave rotary plates 115, 129, respectively. Each track 143 defined in the master rotary plate 115 supports a linear actuator 145 coupled to the inboard end 109 of one of the auxiliary motive bodies 104 and each track 144 in the slave rotary plate 129 supports a linear actuator 146 coupled to the outboard end 111 of one of the auxiliary motive bodies 104. The linear actuators 145, 146 are configured to translate (arrow 147) the auxiliary motive bodies 104 along the tracks 143, 144 and thereby decrease or increase the distance between the auxiliary motive bodies 104 and the primary motive body 101 (e.g., linear actuators 145, 146 are configured to move (arrow 147) the auxiliary motive bodies 104 radially along the tracks 143, 144 defined in the rotary plates 115, 129). The inboard and outboard ends 109, 111 of each of the auxiliary motive bodies 104 are configured to translate synchronously within the tracks 143, 144 in the master and slave rotary plates 115, 129. Accordingly, for each of the auxiliary motive bodies 104, the distance between the auxiliary motive body 104 and the primary motive body 101 remains constant or substantially constant across the length of the auxiliary motive body 104. Additionally, in one embodiment, the auxiliary motive bodies 104 may be separately (i.e., independently) actuatable along the tracks 143, 144, although in one or more alternate embodiments, the auxiliary motive bodies 104 may be actuatable together. The master and slave rotary plates 115, 129 each also define a central opening 148, 149, respectively. The inboard end 127 of the fixed support strut 112 extends through the central opening 148 in the master rotary plate 115 and the outboard end 138 of the fixed support strut 112 extends through the opening 149 in the slave rotary plate 129 and is coupled to the fixed slave endplate housing 128.

Although in the illustrated embodiment the tracks 143, 144 in the rotary plates 115, 129 are evenly spaced apart by approximately 90 degrees azimuthally, in one or more alternate embodiments the tracks 143, 144 may be located in any other suitable positions in the rotary plates 115, 129 depending on the desired angular spacing between the auxiliary motive bodies 104. For instance, in one embodiment, the tracks 143, 144 and the auxiliary motive bodies 104 may be azimuthally separated from approximately 30 to approximately 180 degrees. Additionally, although the auxiliary motive bodies 104 in the illustrated embodiment are equally spaced around the primary motive body 101, in one or more alternate embodiments, the auxiliary motive bodies 104 may be non-uniformly spaced around the primary motive body 101. Further, although in the illustrated embodiment each of the rotary plates 115, 129 includes four tracks 143, 144, in one or more alternate embodiments, the rotary plates 115, 129 may define any other suitable number of tracks 143, 144 depending on the desired number of auxiliary motive bodies 104 (i.e., depending on the desired number of auxiliary motive bodies 104, each of the rotary plates 115, 129 may define a corresponding number of tracks 143, 144). In one embodiment, the tracks 143, 144 are from approximately 2 inches to approximately 4 inches long such that the radial positions of each of the auxiliary motive bodies 104 may be varied from approximately 2 inches to approximately 4 inches. In one or more alternate embodiments, the tracks 143, 144 may have any other suitable length. These values listed for the number, angular spacing, and lengths of the tracks 143, 144 are simply exemplary and will change, depending, for instance, on the design, scale, and application of the dynamically controllable lifting device 100. As described in more detail below, the radial positions of the auxiliary motive bodies 104 relative to the primary motive body 101 may be selected based on the desired aerodynamic interaction between the auxiliary motives bodies 104 and the primary motive body 101 when the dynamically controllable force-generating device 100 is translated through a fluid (e.g., air or water) or when a fluid is otherwise flowing over the dynamically controllable force-generating device 100.

Still referring to the embodiment illustrated in FIGS. 3B and 3C, the rotary plate drive motor 117 is an outrunner motor having an inner, fixed stator 150 coupled proximate to the inboard end 127 of fixed support strut 112 and an outer rotor 151 coupled to the master rotary plate 115. In the illustrated embodiment, the outer rotor 151 of the rotary plate drive motor 117 is coupled to the master slipring assembly 118 and the master slipring assembly 118 is coupled to the master rotary plate 115. The rotor 151 of the rotary plate drive motor 117 is also coupled to an inboard end 152 of the rotary plate drive shaft 113, and an outboard end 153 (see FIG. 3C) of the rotary plate drive shaft 113 is coupled to the slave rotary plate 129 of the slave endplate assembly 110. In the illustrated embodiment, the outboard end 153 of the rotary plate drive shaft 113 is coupled to the slave slipring assembly 132 and the slave slipring assembly 132 is coupled to the slave rotary plate 129. The engagement between rotor 151 of the rotary plate drive motor 117 and the rotary plate drive shaft 113 transmits torque to the slave rotary plate 129 of the slave endplate assembly 110. Accordingly, the rotary plate drive motor 117 is configured to rotate (arrows 125, 137) both the master rotary plate 115 and the slave rotary plate 129 and thereby change the positions of the auxiliary motive bodies 104 around the primary motive body 101 (e.g., the rotary plate drive motor 117 is configured to change the circumferential or azimuthal positions of the auxiliary motive bodies 104 around the primary motive body 101). Additionally, the rotary plate drive motor 117 is configured to synchronously rotate (arrows 125, 137) the master and slave rotary plates 115, 129 on the master and slave endplate assemblies 108, 110 to change the azimuthal positions of the auxiliary motive bodies 104 around the primary motive body 101. As described below, the azimuthal positions of the auxiliary motive bodies 104 around the primary motive body 101 may be selected based on the desired aerodynamic interaction between the auxiliary motives bodies 104 and the primary motive body 101 when the dynamically controllable force-generating device 100 is translated through a fluid (e.g., air or water) or when a fluid is otherwise flowing over the dynamically controllable force-generating device 100.

With continued reference to the embodiment illustrated in FIGS. 3B and 3C, the inboard and outboard ends 109, 111 of each of the auxiliary motive bodies 104 are supported by radial bearings 154 slidably received in the tracks 143, 144 defined in the master and slave rotary plates 115, 129. The radial bearings 154 facilitate rotation (arrow 105) of the auxiliary motive bodies 104 about the respective longitudinal axis. 106 of the auxiliary motive bodies 104. The inboard and outboard ends 109, 111 of each of the auxiliary motive bodies 104 are each also operatively coupled to drive motors 155. The drive motors 155 are configured to rotate (arrow 105) the auxiliary motive bodies 104 about the longitudinal axes 106 of the auxiliary motive bodies 104. As described in detail below, the rotation rate of the auxiliary motive bodies 104 may be selected based on the desired aerodynamic interaction between the auxiliary motives bodies 104 and the primary motive body 101 when the dynamically controllable force-generating device 100 is translated through a fluid (e.g., air or water) or when a fluid is otherwise flowing over the dynamically controllable force-generating device 100.

With reference now to the embodiment illustrated in FIGS. 4A and 4B, the primary motor 120 is an outrunner motor having an inner, fixed stator 156 coupled to the master slipring assembly 118 and an outer rotor 157 coupled to the primary motive body 101. The primary motor 120 is housed between rotary plate drive shaft 113 and the primary motive body 101. An outer surface 158 of the rotor 157 of the primary motor 120 engages an inner surface 159 of the primary motive body 101. Accordingly, the rotor 157 of the primary motor 120 is configured to rotate (arrow 102 in FIG. 1) the primary motive body 101 about the longitudinal axis 103 of the primary motive body 101. In one or more alternate embodiments, the primary motor 120 may be configured to rotate (arrow 102) the primary motive body 101 about any other axis suitable for the shape of the primary motive body 101 (e.g., an airfoil shape) and the desired aerodynamic properties of the primary motive body 101. Although in the illustrated embodiment the longitudinal axis 103 about which the primary motor 120 is configured to rotate (arrow 102) the primary motive body 101 is coaxial with an axis of symmetry of the primary motive body 101, in one or more embodiments, the longitudinal axis 103 about which the primary motor 120 is configured to rotate (arrow 102) the primary motive body 101 may be spaced apart from an axis of symmetry of the primary motive body 101. For instance, in an embodiment in which the primary motive body 101 is a shape of revolution, an axis of symmetry of the shape of revolution may be spaced apart from the longitudinal axis 103 about which the primary motive body 101 rotates (arrow 102).

As described in more detail below, when the dynamically controllable force-generating device 100 is translated through a fluid (e.g., air or water) or a fluid otherwise impacts the dynamically controllable force-generating device 100, the rotation (arrow 102) of the primary motive body 101 generates a force perpendicular to the direction in which the fluid is flowing over the dynamically controllable force-generating device 100. For instance, in an embodiment in which the dynamically controllable force-generating device 100 is incorporated as a wing of an aircraft, the rotation (arrow 102) of the primary motive body 101 by the primary motor 120 generates a lifting force when the propulsion system of the aircraft translates the dynamically controllable lifting 100 device through the air. In another embodiment in which the dynamically controllable lifting device 100 is integrated into a wind turbine (e.g., a wind turbine including a plurality of dynamically controllable force-generating devices 100, rather than a series of conventional blades, circumferentially disposed around a hub), the rotation (arrow 102) of the primary motive body 101 by the primary motor 120 generates a tangential force configured to spin the dynamically controllable force-generating devices 100 when wind impacts the wind turbine. Accordingly, the dynamically controllable force-generating devices 100 of the present disclosure may be configured to function as either part of the propulsion system of a vehicle (e.g., a wing of an aircraft or a sail of a ship) or as part of an energy-harvesting device (e.g., a blade of a wind turbine).

In one embodiment, the rotation rate of the primary motive body 101 may be set to approximately twice the free-stream velocity of the fluid passing over the dynamically controllable lifting device 100. For instance, in one embodiment in which the dynamically controllable lifting device 100 is incorporated into a wind turbine, the primary motive body 101 has a diameter of approximately 10 inches (a circumferential length of approximately 31.4 inches), and the free-stream velocity of the wind striking the wind turbine is approximately 25 mph, the rotation rate of the primary motive body 101 may be selected to be approximately 1682 revolutions per minute (“rpm”) or faster (i.e., 31.4 inches×1682 rpm≈2×25 mph). In one or more alternate embodiments, the rotation rate of the primary motive body 101 may be set to any other suitable speed relative to free-stream velocity of the fluid passing over the dynamically controllable force-generating device 100, such as, for instance, less than or greater than twice the free-stream velocity of the fluid. These values listed for the rotation rate of the primary motive body 101 are simply exemplary and will change, depending, for instance, on the design, scale, and application of the dynamically controllable lifting device 100.

In the embodiment illustrated in FIGS. 3C and 4A, the slave endplate assembly 110 also includes a rotary bearing 160 coupled to the inner surface 142 of the slave rotary plate 129. Additionally, the rotary bearing 160 is housed between the rotary plate drive shaft 113 and the primary motive body 101. The rotary bearing 160 is configured to rotatably support the outboard end 111 of the primary motive body 101 (e.g., the rotary bearing 160 rotatably supports the inner surface 159 of the primary motive body 101). Accordingly, the rotary bearing 160 is configured to permit the primary motive body 101 to rotate (arrow 102 in FIG. 1) relative to the slave rotary plate 129 and thereby substantially prevent the primary motive body 101 from transmitting torque to slave rotary plate 129 of the slave endplate assembly 110. Accordingly, rotation (arrow 102) of the primary motive body 101 does not alter the azimuthal positions of the auxiliary motive bodies 104 supported by the rotary plates 115, 129.

With reference now to the embodiment illustrated in FIGS. 3C, 4A, and 4B, the printed circuit board (PCB) 119 of the master endplate assembly 108 is housed behind master rotary plate 115 and is configured to rotate synchronously with the master rotary plate 115 (i.e., the PCB 119 is configured to rotate as the rotary plate drive motor 117 rotates (arrow 125) the rotary plate 115 to change the azimuthal positions of the auxiliary motive bodies 104 around the primary motive body 101). The PCB 119 includes microcontrollers configured to receive input signals from a command module (e.g., a command module contained in the device or vehicle into which the dynamically controllable force-generating device 100 is incorporated) and to output command signals to the drive motors 155, the linear actuators 145, and the rotary plate drive motor 117 to control the rotation rate, the radial positions, and azimuthal positions, respectively, of the auxiliary motive bodies 104. The microcontrollers on the PCB 119 are also configured to receive input signals from the command module and to output command signals to the primary motor 120 to set the rotation rate of the primary motive body 101.

With continued reference to the embodiment illustrated in FIG. 4A, the fixed support strut 112 defines a central opening 161 for receiving electrical wiring 162 extending from the PCB 119 of the master endplate assembly 108 to the PCB 131 of the slave endplate assembly 110 (i.e., the fixed support strut 112 functions as a conduit for routing electrical wiring 162 to the PCB 131 of the slave endplate assembly 110). The PCB 131 of the slave endplate assembly 110 contains microcontrollers configured to receive input signals and output command signals to the drive motors 155 coupled to the outboard ends 111 of the auxiliary motive bodies 104. In one embodiment, the central opening 161 in the support strut 112 may also house one or more sleeves 163 enshrouding the electrical wires 162 to prevent the electrical wires 162 from chafing against the support strut 112. The inboard end 127 of the fixed support strut 112 extending through the central opening 126 in the master endplate housing 114 also facilitates electrically connecting the wires 162 in the central opening 161 in the support strut 112 to the electrical system of the device (e.g., an aircraft, a ship, or a wind turbine) into which the dynamically controllable force-generating device 100 is incorporated.

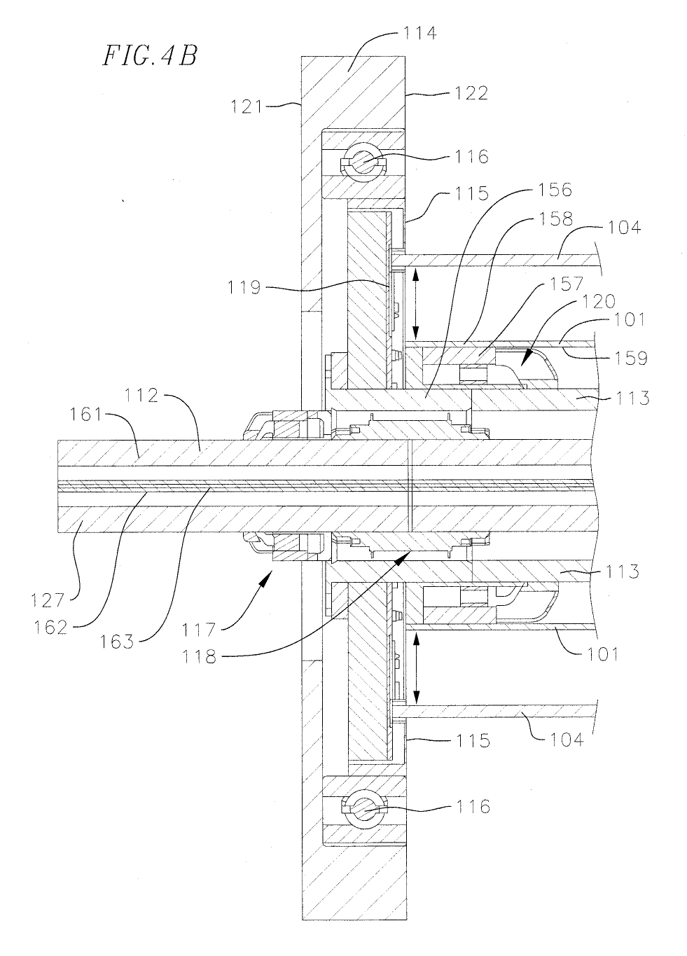

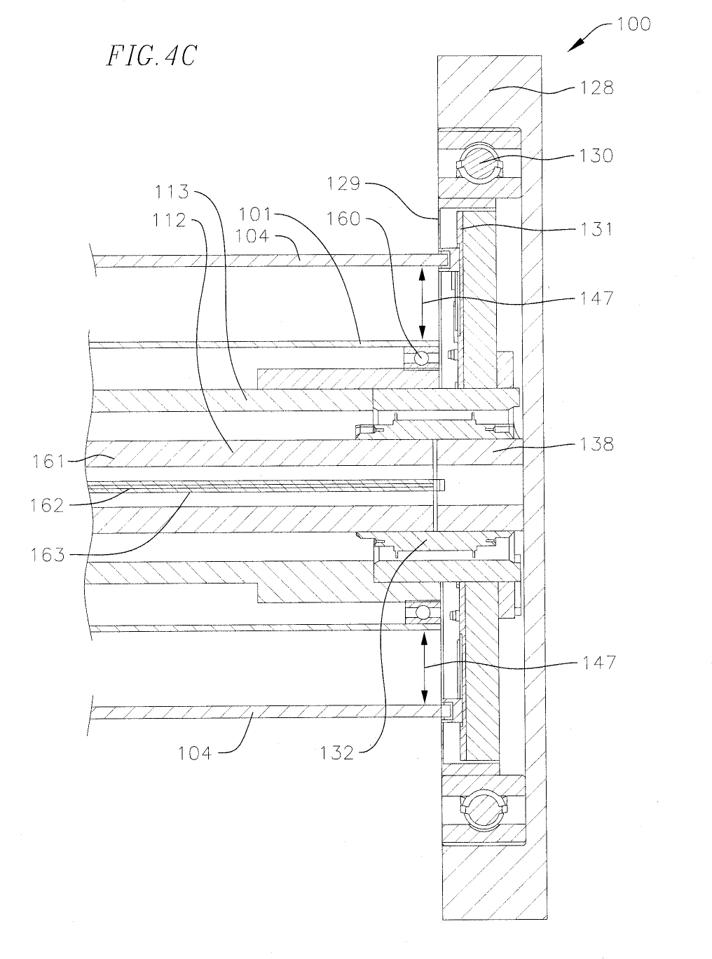

With reference now to FIGS. 5 and 6, the aerodynamic characteristics of the dynamically adjustable force-generating device 100 and, in particular, the effect of the radial and azimuthal positions of the auxiliary motive bodies 104 and the rotation rates of the primary and auxiliary motive bodies 101, 104 on the aerodynamic characteristics of the dynamically adjustable force-generating device 100 will be described. As a fluid 164 (e.g., air or water) impacts the primary motive body 101, streamlines or stream tubes 165 of the fluid 164 deflect around an outer surface of the primary motive body 101. For instance, the fluid 164 may impact the primary motive body 101 by translating the dynamically controllable force-generating device 100 through the fluid 164 (e.g., when the dynamically adjustable force-generating device 100 is incorporated as a wing of an aircraft, a jet engine or propeller of the aircraft translates the dynamically adjustable force-generating device 100 through the air). Alternately, the fluid 164 may impact the primary motive body 101 when the dynamically controllable force-generating body 100 is translationally fixed (e.g., when the dynamically controllable force-generating device 100 is incorporated into a wind turbine and wind impacts the turbine).

With continued reference to the embodiment illustrated in FIGS. 5 and 6, a stagnation point 166 exists where the streamlines 165 split over and under the primary motive body 101. Additionally, viscous shearing between the fluid 164 flow and the outer surface of the primary motive body 101 forms a boundary layer 167 around the outer surface of the primary motive body 101. This viscous shearing generates frictional drag (i.e., viscous drag) on the primary motive body 101. Additionally, the boundary layer 167 separates from the primary motive body 101 at a pair of upper and lower separation points 168, 169, respectively. The separation points 168, 169 define the upstream beginning of a turbulent wake 170 aft of the primary motive body 101. The turbulent wake 170 generates aerodynamic drag (i.e., pressure drag) on the primary motive body 101.

Additionally, as illustrated in FIGS. 5 and 6, the rotation (arrow 102) of the primary motive body 101 deflects the turbulent wake 170 in the direction of rotation. For instance, clockwise rotation (arrow 102) of the primary motive body 101 deflects the turbulent wake 170 downward and counterclockwise rotation (arrow 102) of the primary motive body 101 deflects the turbulent wake 170 upward. Additionally, when the primary motive body 101 is rotating (arrow 102) in the clockwise direction, an upper portion of the primary motive body 101 is rotating in the direction of the advancing streamlines 165 and a lower portion of the primary motive body 101 is rotating in a direction opposite of the advancing streamlines 165. Accordingly, the fluid 164 flow over the upper portion of the primary motive body 101 is accelerated and the fluid 164 flow over the lower portion of the primary motive body 101 is decelerated by the rotation (arrow 102) of the primary motive body 101 in the clockwise direction (i.e., the velocity of the fluid 164 advancing over the upper portion of the primary motive body 101 is increased by the velocity of the retreating primary motive body 101 and the velocity of the fluid 164 advancing over the lower portion of the primary motive body 101 is decreased by the velocity of the advancing primary motive body 101). Accordingly, the fluid 164 flowing over the upper portion of the primary motive body 101 has a higher velocity and a lower pressure than the fluid 164 flowing under the lower portion of the primary motive body 101. This pressure differential generates a resultant force vector R acting on the primary motive body 101. Additionally, in the illustrated embodiment, the resultant force vector R acting on the primary motive body 101 is deflected aft from a vertical axis V by an angle α. The angle α of the resultant force vector R is a function of the two boundary layer separation points 168, 169. The resultant force R can be resolved into a drag force component D and a lifting force component L acting on the primary motive body 101.

With continued reference to the embodiment illustrated in FIG. 6, the auxiliary motive bodies 104 are configured to energize the boundary layer 167 and thereby delay separation of the boundary layer 167 from the primary motive body 101. Movement of the boundary layer separation points 168, 169 (e.g., movement of the upper boundary layer separation point 168 aft to separation point 168′) alters the direction of the resultant force vector R′ acting on the primary motive body 101. For instance, in one embodiment, the upper boundary layer separation point 168 may be moved aft such that the resultant force vector R′ is shifted toward the vertical axis V. Shifting the direction of the resultant force vector R toward the vertical axis V reduces the pressure drag force D′ acting on the primary motive body 101 and increases the lifting force L′ acting on the primary motive body 101. In another embodiment, the resultant force vector R′ may be shifted forward of the vertical axis V such that the resultant force vector R resolves into a component of lift and a component of thrust acting on the primary motive body 101. In one embodiment, the upper boundary layer separation point 168 may be shifted aft to separation point 168′ by moving one of the auxiliary motive bodies 104 azimuthally and/or radially toward the upper boundary layer separation point 168 (e.g., one of the auxiliary motive bodies 104 may be moved proximate to the upper boundary layer separation point 168 to inject fluid momentum in the upper near-wake region to energize the boundary layer 167 and thereby shift the upper boundary layer separation point 168 aft). Additionally, the movement of the upper separation point 168′ aft deflects the turbulent wake 170′ downward compared to the turbulent wake 170 in FIG. 5 when the auxiliary motive body 104 is not present. Accordingly, the auxiliary motive bodies 104 are configured to vector the resultant force R generated by the primary motive body 101 by altering the aerodynamic characteristics of the fluid 164 flowing around the primary motive body 101.

With continued reference to the embodiment illustrated in FIG. 6, the one or more auxiliary motive bodies 104 are also configured to increase the pressure differential across the primary motive body 101. In one embodiment, one of the auxiliary motive bodies 104 may be positioned above the upper portion of the primary motive body 101 and rotated (arrow 105) about its longitudinal axis 106 to accelerate the fluid 164 flowing over the upper portion of the primary motive body 101. Accelerating the fluid 164 flowing over the upper portion of the primary motive body 101 reduces the pressure of the fluid 164 flowing over the upper portion of the primary motive body 101 and thereby increases the magnitude of the resultant force vector R′ acting on the primary motive body 101.

Accordingly, in one embodiment, by changing the azimuthal and/or radial position of the auxiliary motive body 104 positioned under the lower portion of the primary motive body 101 and by rotating the auxiliary motive body 104 positioned above the upper portion of the primary motive body 101 about its longitudinal axis 106, the direction and magnitude of the resultant force vector R may be independently controlled by the auxiliary motive bodies 104. The auxiliary motive bodies 104 may also be configured to reduce or minimize the rapid oscillation in the magnitude and direction of the resultant vector R, which may occur with conventional Magnus devices.

It will be appreciated that the outer surface of the primary motive body 101 is a force-generating motive surface (e.g., a surface configured to generate lift) and the outer surfaces of the auxiliary motive bodies 104 are controlling motive surfaces configured to modify the aerodynamic properties of the fluid flow around the force-generating motive surface of the primary motive body 101. Although in the illustrated embodiment the primary motive body 101 is configured to generate a force (e.g., lift) and the one or more auxiliary motive bodies 104 are configured to modify the aerodynamic properties of the fluid flow around the primary motive body 101, in one or more embodiments, the one or more auxiliary motive bodies 104 may be configured to generate a force (e.g., lift) and the primary motive body 101 may be configured to modify the aerodynamic properties of the fluid flow around the auxiliary motive body 104. For instance, in one embodiment in which the one or more auxiliary motive bodies 104 are larger than primary motive body 101 and/or are rotating (arrow 105) faster than the primary motive body 101 is rotating (arrow 102), the one or more auxiliary motive bodies 104 may be configured to generate a force (e.g., lift) and the primary motive body 101 may be configured to modify the aerodynamic properties of the fluid flow around the auxiliary motive body 104 (i.e., the aerodynamic effect of the primary and auxiliary motive bodies 101, 104 depends, in part, on the size and rotation speed of the auxiliary motive body 104 relative to the size and rotation speed of the primary motive body 101). Additionally, the aerodynamic influence of the primary and auxiliary motive bodies 101, 104 may be changed dynamically during operation of the dynamically controllable force-generating device 100, for instance, by varying the rotation rate (arrow 105) of the one or more auxiliary motive bodies 104 relative to the rotation rate (arrow 102) of the primary motive body 101 (e.g., by increasing the rotation rate of the one or more auxiliary motive bodies 104 and/or by decreasing the rotation rate of the primary motive body 101) and/or by changing the radial and/or azimuthal positions of the one or more auxiliary motive bodies 104 relative to the primary motive body 101.

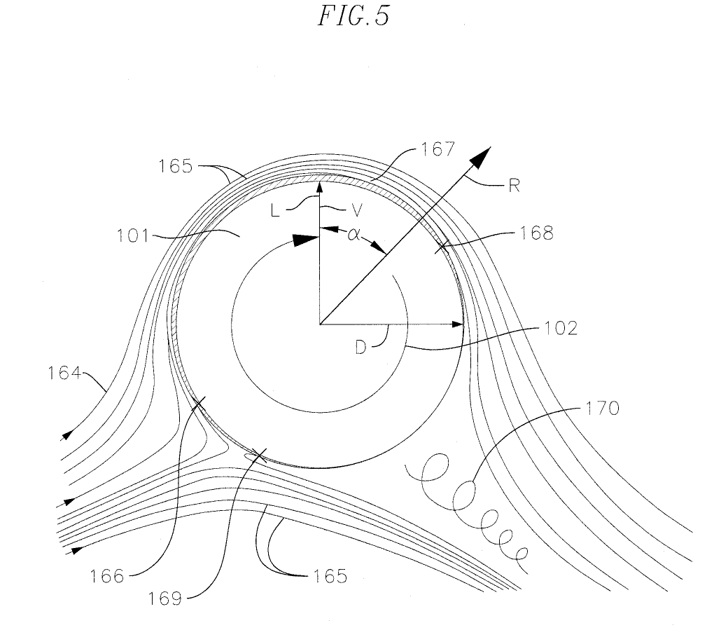

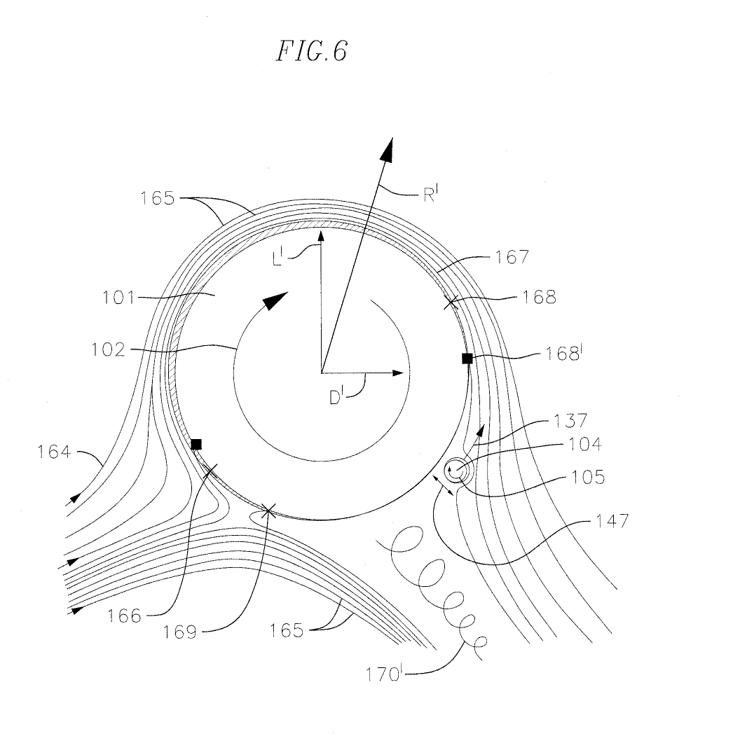

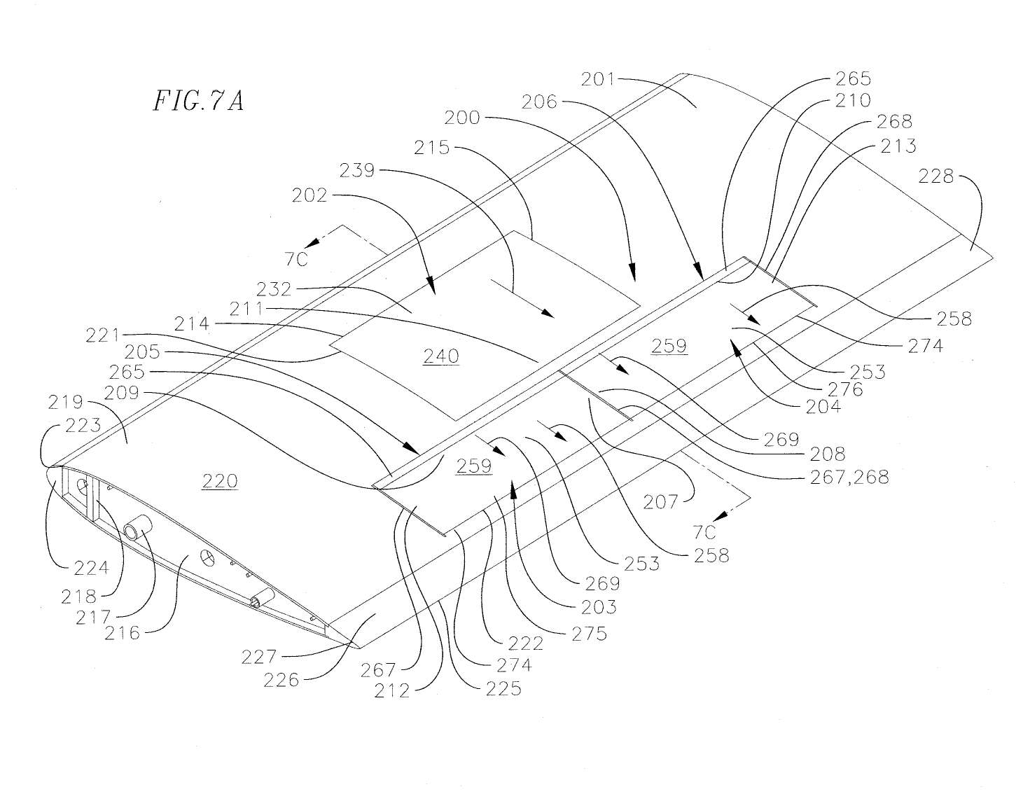

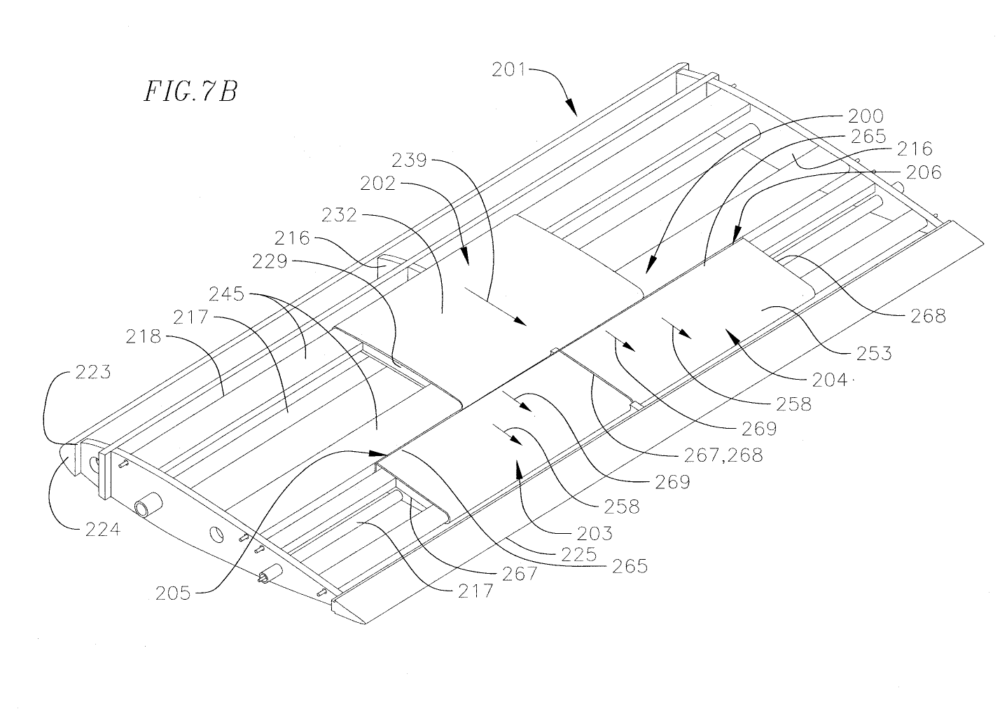

With reference now to FIGS. 7A-7D, a dynamically controllable force-generating device 200 according to another embodiment of the present disclosure is incorporated into a wing 201. In the illustrated embodiment, the dynamically controllable force-generating device 200 includes a force-generating assembly 202, inboard and outboard controlling assemblies 203, 204 downstream of the force-generating assembly 202, and inboard and outboard shroud assemblies 205, 206. As illustrated in FIGS. 7C and 7D, the inboard and outboard shroud assemblies 205, 206 are at least partially housed below the inboard and outboard controlling assemblies 203, 204, respectively. Additionally, as illustrated in FIGS. 7A and 7B, the inboard and outboard controlling assemblies 203, 204 are arranged side-by-side such that an outboard side 207 of the inboard controlling assembly 203 abuts an inboard side 208 of the outboard controlling assembly 204. In one or more alternate embodiments, the inboard and outboard controlling assemblies 203, 204 may be laterally spaced apart by any suitable distance. Further, in the illustrated embodiment, forward ends 209, 210 of the inboard and outboard controlling assemblies 203, 204, respectively, are spaced aft of a rear end 211 of the force-generating assembly 202 by any suitable distance. Although in the illustrated embodiment the dynamically controllable force-generating device 200 includes two controlling assemblies 203, 204 arranged side-by-side, in one or more alternate embodiments, the dynamically controllable force-generating device 200 may include any other suitable number of controlling assemblies, such as, for instance, from one to ten controlling assemblies, and the controlling assemblies 203, 204 may have any other suitable arrangement on the wing 201 relative to the force-generating assembly 202. Furthermore, although in the illustrated embodiment an inboard side 212 of the inboard controlling assembly 203 and an outboard side 213 of the outboard controlling assembly 204 extend beyond inboard and outboard sides 214, 215, respectively, of the force-generating assembly 202, in one or more alternate embodiments, the controlling assemblies 203, 204 may not extend beyond the inboard and outboard sides 214, 215 of the force-generating assembly 202 (e.g., the inboard and outboard sides 212, 213 of the inboard and outboard controlling assemblies 203, 204 may be aligned with the inboard and outboard sides 214, 215, respectively, of the force-generating assembly 202 or the inboard and outboard sides 212, 213 of the inboard and outboard controlling assemblies 203, 204 may be laterally spaced inward from the inboard and outboard sides 214, 215, respectively, of the force-generating assembly 202).

With reference now to the embodiment illustrated in FIGS. 7A and 7B, the wing 201 includes a plurality of laterally spaced ribs 216 and a plurality of spars 217 (e.g., tubular spars) extending transversely between and interconnecting the ribs 216. In one embodiment, the wing 201 may also include one or more support struts 218 extending transversely and interconnecting the ribs 216. Additionally, in the illustrated embodiment, the wing 201 includes a skin 219 (see FIG. 7A) covering the ribs 216, the spars 217, and the support struts 218. The skin 219 may have any suitable cross-sectional shape in a plane parallel to the ribs 216 depending on the desired aerodynamic performance characteristics of the wing 201, such as, for instance, an airfoil shape developed by National Advisory Committee for Aeronautics (NACA) (e.g., NACA0015). Additionally, an upper surface 220 of the skin 219 includes one or more openings configured to receive the force-generating assembly 202 and the inboard and outboard controlling assemblies 203, 204. In the illustrated embodiment, the upper surface 220 of the skin 219 includes a first opening 221 the shape and size of which matches or substantially matches the shape and size of the force-generating assembly 202 and a second opening 222 the shape and size of which matches or substantially matches the combined shape and size of the inboard and outboard controlling assemblies 203, 204.

Additionally, in the illustrated embodiment, a leading edge 223 of the wing 201 includes one or more slats 224 and a trailing edge 225 of the wing 201 includes one or more flaps and/or ailerons 226 (e.g., an inboard portion 227 of the trailing edge 225 of the wing 201 proximate the vehicle or other structure into which the wing 201 is incorporated may include one or more flaps and an outboard portion 228 of the trailing edge 225 of the wing 201 distal to the vehicle or other structure may include one or more ailerons).

With reference now to the embodiment illustrated in FIG. 7C, the force-generating assembly 202 includes a profile base 229, a front gear 230 provided at a front end of the profile base 229, a rear gear 231 provided at a rear end of the profile base 229, a force-generating motive surface 232 extending around the gears 230, 231 and at least a portion of the profile base 229, and one or more drive motors coupled to the gears 230, 231. In the illustrated embodiment, two drive motors are coupled to the gears 230, 231 by two drive shafts 233, 234, respectively. In the illustrated embodiment, the force-generating motive surface 232 is on a belt 235 having a toothed inner surface 236 configured to engage teeth 237, 238 on the gears 230, 231. Although in one embodiment the force-generating assembly 202 may include a separate drive motor coupled to each of the gears 230, 231, in one or more embodiments, the force-generating assembly 202 may include a single drive motor coupled to one of the gears 230, 231 and the gears 230, 231 may be coupled together, for instance, by one or more linkages. The one or more drive motors are configured to rotate the gears 230, 231 synchronously and thereby move (arrow 239) the force-generating motive surface 232 around the gears 230, 231 and the profile base 229.

With continued reference to the embodiment illustrated in FIGS. 7A and 7C, an area or portion 240 of the force-generating motive surface 232 is exposed through the first opening 221 in the upper surface 220 of the skin 219 of the wing 201. Accordingly, the exposed area 240 of the force-generating motive surface 232 is exposed to fluid flowing over the upper surface 220 of the wing 201 when the wing 201 and the dynamically controllable force generating device 200 are introduced into a fluid flow stream. As described in more detail below, the exposed portion 240 of the force-generating motive surface 232 is configured to modify the aerodynamic properties of the wing 201 and the dynamically controllable lifting device 200 (e.g., increasing lift and/or reducing drag). In the illustrated embodiment, the force-generating assembly 202 is configured to move (arrow 239) the exposed portion 240 of the force-generating motive surface 232 in the same direction as the fluid flowing over the wing 201 (e.g., the exposed portion 240 of the force-generating motive surface 232 moves in a direction from the leading edge 223 of the wing 201 to a trailing edge 225 of the wing 201).

In the illustrated embodiment, the profile base 229 is shaped such that the exposed portion 240 of the force-generating motive surface 232 matches or substantially matches the curvature of the upper surface 220 of the skin 219 of the wing 201 (e.g., the profile base 229 conforms the exposed portion 240 of the force-generating surface 232 into the profile of the upper surface 220 of the skin 201 proximate the inboard and outboard sides 214, 215, respectively, of the force-generating assembly 202). Accordingly, in the illustrated embodiment, the exposed portion 240 of the force-generating motive surface 232 is flush or substantially flush with the upper surface 220 of the skin 219 of the wing 201. For instance, in one embodiment, an upper surface 241 of the profile base 229 may have a portion of a NACA airfoil shape (e.g., NACA0015) such that the exposed portion 240 of the force-generating motive surface 232, which moves over the upper surface 241 of the profile base 229, has a corresponding portion of the NACA airfoil shape. In one or more alternate embodiments, the force-generating assembly 202 may be provided without the profile base 229.

In one or more embodiments, the exposed portion 240 of the force-generating motive surface 232 may not follow or match the curvature of the upper surface 220 of the skin 219 (e.g., the exposed portion 240 of the force-generating motive surface 232 may be straight or substantially straight). In one or more embodiments, the force-generating assembly may be provided without the profile base 229 and the force-generating assembly 202 may include one or more additional gears arranged between the front and rear gears 230, 231 such that the exposed portion 240 of the force-generating motive surface 232 conforms or substantially conforms to the curvature of the upper surface 220 of the skin 219. In one or more embodiments, the force-generating assembly 202 may include any other suitable mechanism or mechanisms (e.g., guides) configured to conform the exposed portion 240 of the force-generating motive surface 232 into the profile of the upper surface 220 of the skin 219 proximate the inboard and outboard sides 214, 215, respectively, of the force-generating assembly 202. Additionally, in one embodiment, the force-generating assembly 202 may include one or more mechanisms (e.g., bearings) to facilitate the movement (arrow 239) of the force-generating motive surface 232 along the upper surface 241 of the profile base 229.

Additionally, in the illustrated embodiment, a gap 242 is defined between an inner portion 243 of the force-generating motive surface 232 passing under the profile base 229 and an inner surface 244 of the profile base 229 (e.g., the inner portion 243 of the force-generating motive surface 232 passing under the profile base 229 may be straight or substantially straight and the inner surface 244 of the profile base 229 may be curved outward away from the inner portion 243 of the force-generating motive surface 232). Spacing the inner portion 243 of the force-generating motive surface 232 apart from the inner surface 244 of the profile base 229 reduces the friction between the force-generating motive surface 232 and the profile base 229. Additionally, as illustrated in FIG. 7B, the force-generating assembly 202 also includes a plurality of support struts 245 extending transversely across the wing 201 and coupling the profile base 229 to two of the ribs 216 of the wing 201.

With continued reference to the embodiment illustrated in FIG. 7C, the inboard and outboard controlling assemblies 203, 204 each include a profile base 250, a front gear 251 provided at a front end of the profile base 250, a rear gear 252 provided at a rear end of the profile base 250, a controlling motive surface 253 extending around the gears 251, 252 and at least a portion of the profile base 250, and one or more drive motors coupled to the gears 251, 252. In the illustrated embodiment, two drive motors are coupled to the gears 251, 252 by two drive shafts 260, 261, respectively. In the illustrated embodiment, the controlling motive surface 253 is on a belt 254 having a toothed inner surface 255 configured to engage teeth 256, 257 on the gears 251, 252. The one or more drive motors are configured to rotate the gears 251, 252 synchronously and thereby move (arrow 258) the controlling motive surface 253 around the gears 251, 252 and the profile base 250.

In the illustrated embodiment, an area or portion 259 of the controlling motive surface 253 is exposed through the second opening 222 in the upper surface 220 of the skin 219 of the wing 201. Accordingly, the exposed area 259 of the controlling motive surface 253 is exposed to the fluid flowing over the upper surface 220 of the wing 201 and the force-generating motive surface 232 when the wing 201 and the dynamically controllable force generating device 200 are introduced into a fluid flow stream. As described in more detail below, the exposed portions 259 of the controlling motive surfaces 253 are configured to modify the aerodynamic properties of the dynamically controllable lifting device 200. In the illustrated embodiment, the one or more drive motors are configured to move (arrow 258) the exposed areas 259 of the controlling motive surfaces 253 in the same direction as the fluid flowing over the wing 201 and the same direction that the one or more drive motors are configured to move (arrow 239) the force-generating motive surface 232 (e.g., the exposed areas 259 of the controlling motive surfaces 253 are configured to move (arrow 258) in a direction from the leading edge 223 of the wing 201 toward the trailing edge 225 of the wing 201). In one more embodiments, the one or more drive motors of the controlling assemblies 203, 204 may be configured to move the exposed areas 259 of the controlling motive surfaces 253 in a direction opposite to the direction in which the one or more drive motors of the force-generating assembly 202 are configured to move (arrow 239) the force-generating motive surface 232.

Additionally, in one embodiment, the drive motors of the inboard and outboard controlling assemblies 203, 204 are configured to drive the controlling motive surfaces 253 at a surface speed less than the surface speed at which the one or more drive motors of the force-generating assembly 202 are configured to drive the force-generating motive surface 232. In one or more alternate embodiments, the drive motors may be configured to drive the controlling motive surfaces 253 at a surface speed substantially equal to or greater than the surface speed at which the drive motors are configured to drive the force-generating motive surface 232.

In the illustrated embodiment, the area of the exposed portion 240 of the force-generating motive surface 232 may be the same or substantially the same as the combined area of the exposed portions 259 of the controlling motive surfaces 253 of the inboard and outboard controlling assemblies 203, 204. In one or more alternate embodiments, the area of the exposed portion 240 of the force-generating motive surface 232 may be different than the combined area of the exposed portions 259 of the controlling motive surfaces 253 (e.g., the area of the exposed portion 240 of the force-generating motive surface 232 may be larger or smaller than the combined area of the exposed portions 259 of the controlling motive surfaces 253).

With reference now to the embodiment illustrated in FIG. 7D, the inboard and outboard shroud assemblies 205, 206 each include a shroud 265, a shroud actuator 266, and a plurality of endplates 267, 268 supporting the shroud 265. The shroud actuators 266 are configured to move (arrow 269) the shrouds 265 between a retracted position and one or more extended or deployed positions. In one embodiment, the inboard and outboard shroud assemblies 205, 206 may each include a spool around which the shroud 265 is wound when it is in the retracted position. In the retracted positions, the shrouds 265 do not cover any portion of the exposed areas 259 of the controlling motive surfaces 253 of the inboard and outboard controlling assemblies 203, 204. In a deployed position, the shrouds 265 cover at least a portion of the exposed area 259 of the controlling motive surfaces 253 of the inboard and outboard controlling assemblies 203, 204. Covering at least a portion of the controlling motive surfaces 253 reduces the effective exposed area 259 of the controlling motive surfaces 253. Additionally, the deployment of the shrouds 265 is configured to change the effective distance between the force-generating motive surface 232 and the controlling motive surfaces 253 (e.g., deploying the shrouds 265 into extended positions shifts the effective exposed areas 259 of the controlling motive surfaces 253 aft toward the trailing edge 225 of the wing 201 and away from the force-generating motive surface 232).

In the embodiment illustrated in FIG. 7B, the inboard and outboard shroud assemblies 205, 206 each include an inboard endplate 267 and an outboard endplate 268. In the illustrated embodiment, one endplate 267 is shared between the inboard shroud assembly 205 and the outboard assembly 206 (i.e., a single endplate 267, 268 is at the outboard end of the inboard shroud assembly 205 and at the inboard end of the outboard shroud assembly 206). Additionally, in the illustrated embodiment, the endplates 267, 268 are also coupled to the ends of the profile bases 250 of the inboard and outboard controlling assemblies 203, 204.

In the illustrated embodiment, each endplate 267, 268 defines a track 270 having a plurality of rollers (e.g., bearings) received therein. In the illustrated embodiment, an outboard facing surface of the inboard endplate 267 and an inboard facing surface of the outboard endplate 268 define a track 270. Additionally, in the illustrated embodiment, both inboard and outboard facing surfaces of the endplate 267, 268 shared between the inner and outer shroud assemblies 205, 206 define a track 270. The ends of each shroud 265 extend into the tracks 270 and are slidably supported on the rollers. Accordingly, the tracks 270 in the endplates 267, 268 are configured to support and guide the shrouds 265 as they move (arrow 269) between the retracted position and one or more extended positions. As the shrouds 265 move between the retracted position and an extended position, the shrouds 265 extends up between the force-generating motive surface 232 and the respective controlling motive surface 253 and then turn aft toward the trailing edge 225 of the wing 201 to cover at least a portion of the exposed area 259 of the respective controlling motive surface 253. Additionally, in the illustrated embodiment, the tracks 270 extend along the entire length of the exposed areas 259 of the controlling motive surfaces 253 (i.e., the tracks 270 extend fore and aft along the wing 201 to the same extent as the one or more controlling motive surfaces 253) such that the shrouds 265 are configured to cover any portion of the exposed areas 259 of the controlling motive surfaces 253, including completely covering the exposed areas 259 of the controlling motive surfaces 253.

In the embodiment illustrated in FIG. 7D, the exposed areas 259 of the controlling motive surfaces 253 are recessed below the upper surface 220 of the skin 219 of the wing 201 by a distance d. Additionally, in one embodiment, the distance d that the exposed areas 259 of the controlling motive surfaces 253 are recessed below the skin 219 of the wing 201 may be equal or substantially equal to the thicknesses of the shrouds 265. Accordingly, in one embodiment, when the shrouds 265 are in extended positions covering at least portions of the exposed areas 259 of the controlling motive surfaces 253, the shrouds 265 are flush with the upper surface 220 of the skin 219 of the wing 201.

Additionally, in one embodiment, the shroud 265 of the inboard shroud assembly 205 and the shroud 265 of the outboard shroud assembly 206 may be independently actuatable, the significance of which is described below. For instance, in one embodiment, the shroud 265 of the inboard shroud assembly 205 may be actuated into an extended position to cover at least a portion of the exposed area 259 of the controlling motive surface 253 of the inboard controlling assembly 203 and the shroud 265 of the outboard shroud assembly 206 may remain in the retracted position such that no portion of the exposed area 259 of the controlling motive surface 253 of the outboard controlling assembly 204 is covered by the shroud 265. Additionally, the shrouds 265 of both the inboard and outboard shroud assemblies 205, 206 may be actuated into extended positions, but the shroud 265 of one of the shroud assemblies 205, 206 may cover a greater portion of the exposed area 259 of the respective controlling motive surface 253 than the shroud 265 of the other shroud assembly 205, 206.

In the embodiment illustrated in FIGS. 7A-7C, the dynamically controllable force-generating device 200 is located at one of the ribs 216 along the wing 201. In the illustrated embodiment, the rib 216 defines a forward notch 271 configured to receive a portion of the force-generating assembly 202 and a rear notch 272 configured to receive a portion of the inboard and outboard controlling assemblies 203, 204 and a portion of the inboard and outboard shroud assemblies 205, 206. Although in the illustrated embodiment the dynamically controllable force-generating device 200 is located at one of the ribs 216 along the wing 201, in one or more alternate embodiments, the dynamically controllable force-generating device 200 may be located at any other suitable location on the wing 201, such as, for instance, between two adjacent ribs 216. Additionally, as illustrated in FIG. 7B, the inboard and outboard shroud assemblies 205, 206 each also include a support strut 273 supporting the shroud actuator 266. In the illustrated embodiment, the support strut 273 extends transversely between the inboard and outboard endplates 267, 268 and opposite ends of the support strut 273 are coupled to the inboard and outboard endplates 267, 268. Additionally, in one embodiment, a portion of the support strut 273 rests on one of the ribs 216 of the wing 201.

With reference again to the embodiment illustrated in FIGS. 7A and 7C, the upper surface 220 of the skin 219 of the wing 201 also includes a lip 274 overhanging trailing edge portions 275, 276 of the controlling motive surfaces 253 of the inboard and outboard controlling assemblies 203, 204, respectively. In the illustrated embodiment, the lip 274 has a concave shape corresponding to the convex shape of the portions of the controlling motive surfaces 253 extending around the rear gears 252. Additionally, in one embodiment, when the shrouds 265 are in the fully deployed or extended positions, the shrouds 265 extend underneath the lip 274 on the skin 219 of the wing 201. Additionally, in the illustrated embodiment, no gap or only a small gap is defined between the lip 274 and the shrouds 265 when the shrouds 265 are in the fully deployed position. The lip 274 is configured to prevent aerodynamic separation of fluid flowing over the wing 201 and the dynamically controllable force-generating device 200 when the fluid transitions from the controlling motive surfaces 253 of the inboard and outboard controlling assemblies 203, 204 to the upper surface 220 of the skin 219 downstream of the controlling motive surfaces 253.

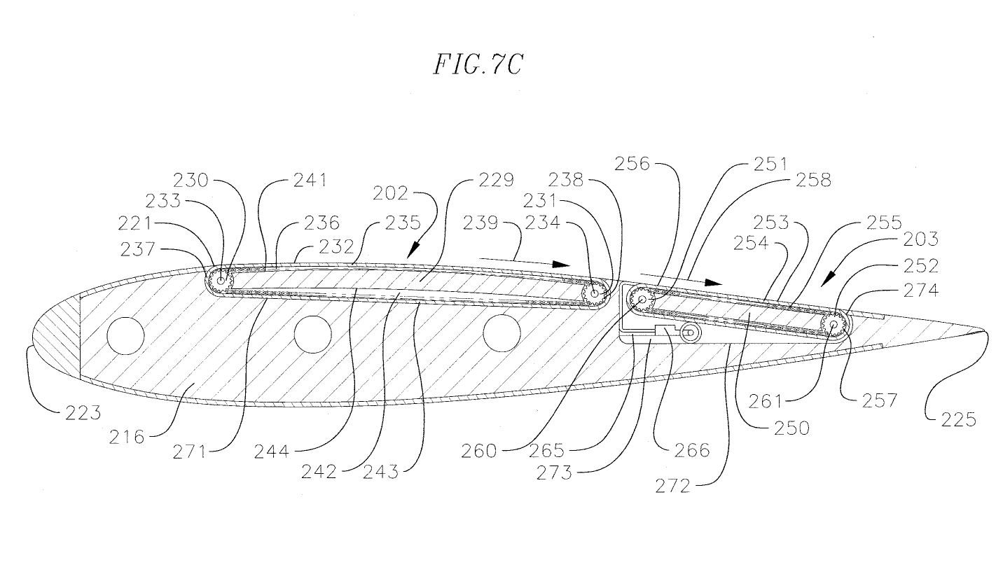

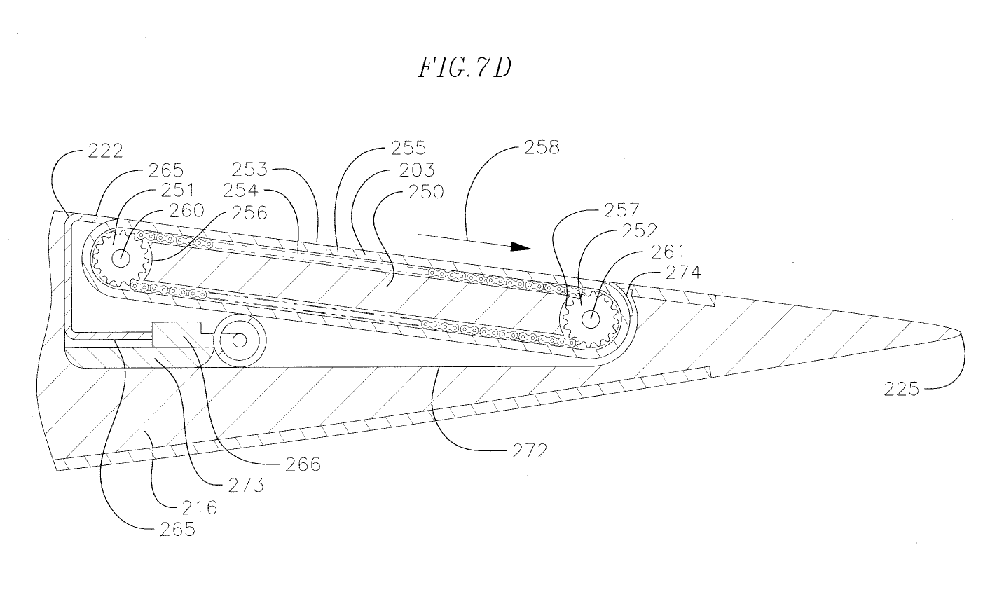

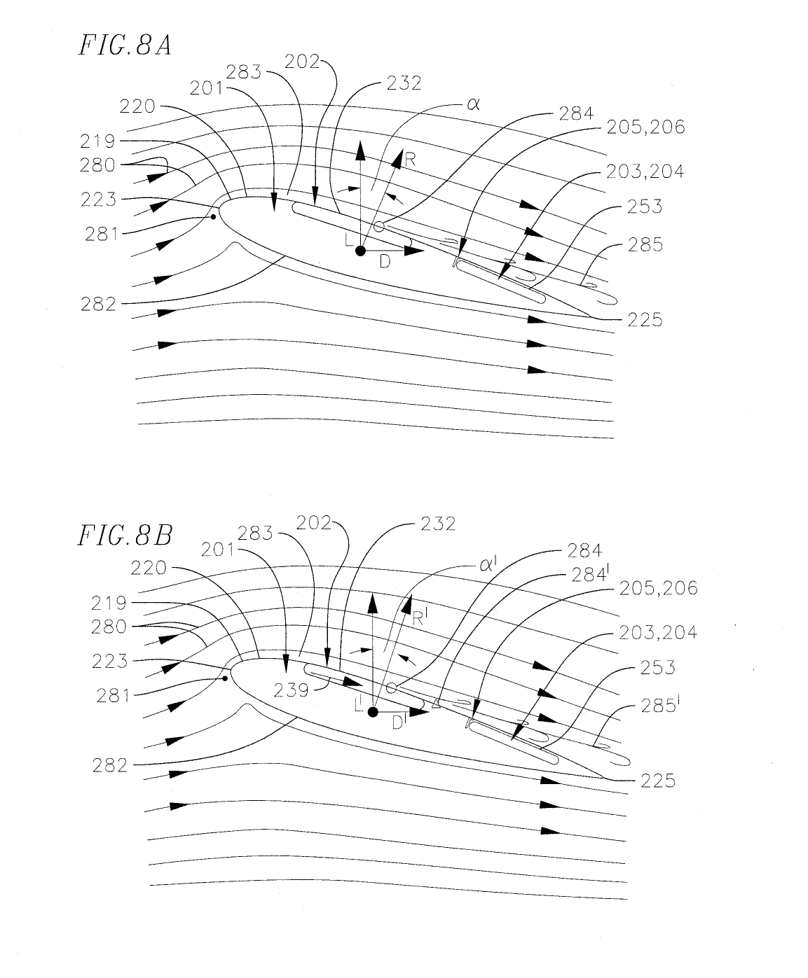

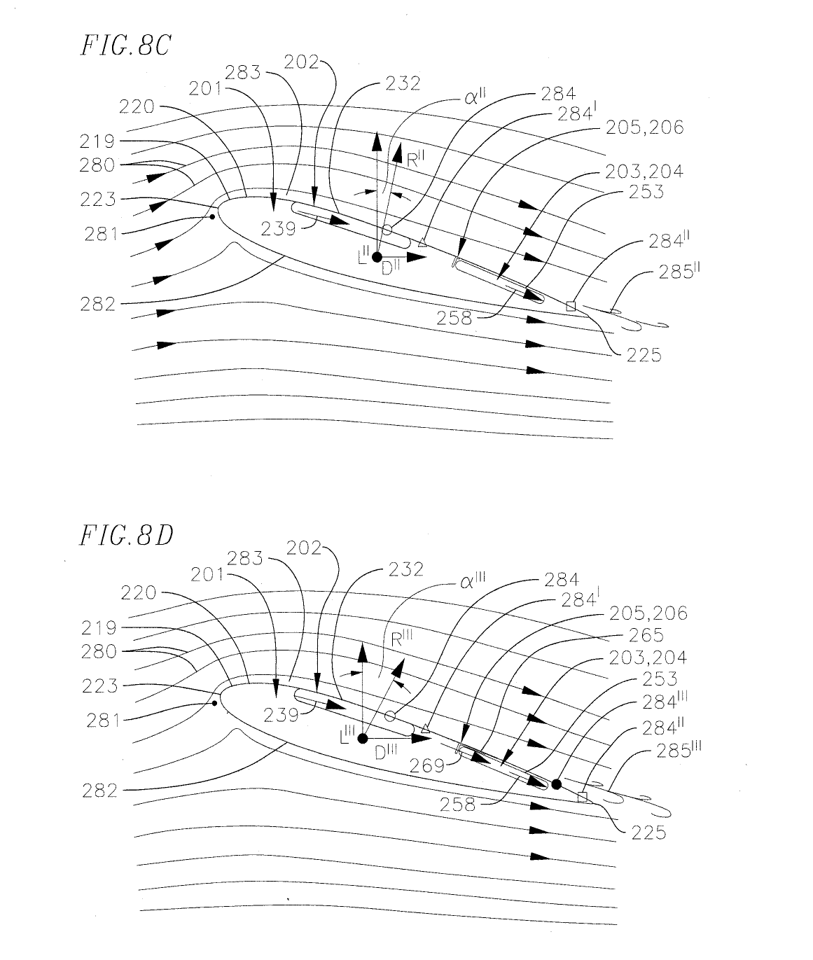

With reference now to FIGS. 8A-8C, the aerodynamic characteristics of the wing and the dynamically controllable force-generating device 200 and, in particular, the effect of the force-generating assembly 202, the inboard and outboard controlling assemblies 203, 204, and the inboard and outboard shroud assemblies 205, 206 on the aerodynamic characteristics of the wing 201 and the dynamically controllable force-generating device 200 will be described. As a fluid (e.g., air or water) impacts the leading edge 223 of the wing 201, streamlines or stream tubes 280 of the fluid deflect around the skin 219 of the wing 201. When the dynamically controllable force-generating device 200 and the wing 201 are introduced into the fluid flow stream, the fluid flow over the wing 201 is first incident on the force-generating motive surface 232 of the force-generating assembly 202 and then incident on the controlling motive surfaces 253 of the inboard and outboard controlling assemblies 203, 204. The fluid may impact the wing 201 and the dynamically controllable force-generating device 200 by translating the wing 201 and the dynamically controllable force-generating device 200 through the fluid (e.g., when the wing 201 and the dynamically controllable force-generating device 200 are incorporated into an aircraft, a jet engine or propeller of the aircraft translates the wing 201 and the dynamically controllable force-generating device 200 through the air). Alternately, the fluid may impact the wing 201 and the dynamically controllable force-generating device 200 when the wing 201 and the dynamically controllable force-generating device 200 are translationally fixed (e.g., when the wing 201 and the dynamically controllable force-generating device 200 are incorporated into a wind turbine and wind impacts the turbine).

With continued reference to the embodiment illustrated in FIGS. 8A-8C, a stagnation point 281 exists where the streamlines 280 split over and under the wing 201 (i.e., the stagnation point 281 is defined where the streamlines 280 split between the upper surface 220 and a lower surface 282 of the skin 219 of the wing 201). Additionally, viscous shearing between the fluid flow and the skin 219 of the wing 201 forms a boundary layer 283 around the skin 219 of the wing 201. This viscous shearing generates frictional drag (i.e., viscous drag) on the wing 201:

FIG. 8A illustrates the aerodynamic properties of the wing 201 and the dynamically controllable force-generating device 200 when neither the force-generating motive surface 232 nor the controlling motive surfaces 253 are moving and the shrouds 265 of the inboard and outboard shroud assemblies 205, 206 are in the retracted position. As illustrated in FIG. 8A, the boundary layer 283 separates from the upper surface 220 of the skin 219 of the wing 201 at an upper separation point 284. In the illustrated embodiment, the upper separation point 284 is located on the force-generating motive surface 232 of the force-generating assembly 202. The separation point 284 defines the upstream beginning of a turbulent wake 285. The turbulent wake 285 generates aerodynamic drag (i.e., pressure drag) on the wing 201. Additionally, the fluid flowing over the upper surface 220 of the wing 201 has a higher velocity and a lower pressure than the fluid flowing under the lower surface 282 of the wing 201. This pressure differential generates a resultant force vector (R) acting on the wing 201. Additionally, in the illustrated embodiment, the resultant force vector (R) acting on the wing 201 is deflected aft from a vertical axis by an angle α. The angle α and magnitude of the resultant force vector (R) is a function of the position of the upper separation point 284 of the boundary layer 283. The resultant force (R) can be resolved into a drag force component (D) and a lifting force component (L) acting on the wing 201.

FIG. 8B illustrates the aerodynamic properties of the wing 201 and the dynamically controllable force-generating device 200 when the force-generating motive surface 232 is actuated to move (arrow 239) in the direction of the advancing streamlines 280 and neither of the controlling motive surfaces 253 are moving. As illustrated in FIG. 8B, the fluid flow over the upper surface 220 of the skin 219 of the wing 201 is accelerated by the movement of the force-generating motive surface 239 in the direction of the advancing streamlines 280. The movement (arrow 239) of the force-generating motive surface 232 also energizes the boundary layer 283 and thereby delays separation of the boundary layer 283 from the upper surface 220 of the skin 219 of the wing 201. Thus, in FIG. 8B, the boundary layer 283 separates at upper separation point 284′, which is aft of the upper separation point 284 in FIG. 8A when the force-generating motive surface 232 is not moving. That is, the upper separation point 284 of the boundary layer 283 in FIG. 8A moves aft (i.e., toward the trailing edge 225 of the wing 201) to upper separation point 284′ when the force-generating motive surface 232 is actuated to move (arrow 239) in the direction of the streamlines 280. In the illustrated embodiment, the upper separation point 284′ of the boundary layer 283 is between the force-generating motive surface 232 and the controlling motive surfaces 253 (i.e., the separation point 284′ is aft of the trailing edge of the force-generating motive surface 232 and forward of the leading edges of the controlling motive surfaces 253). Additionally, the movement of the upper separation point 284′ aft deflects the turbulent wake 285′ downward compared to the turbulent wake 285 in FIG. 8A when the force-generating motive surface 232 is not moving.

Still referring to FIG. 8B, when the force-generating motive surface 232 is moving (arrow 239) in the direction of the advancing streamlines 280, the pressure differential across the wing 201 creates a resultant force vector R′ acting on the wing 201 that is deflected aft from the vertical axis by an angle α′. The resultant force vector R′ can be resolved into a drag force component D′ and a lifting force component L′. Due to the movement of the upper separation point 284′ aft and the deflection of the turbulent wake 285′ downward, the resultant force vector R′ acting on the wing 201 has a different magnitude and sense than the resultant force vector R acting on the wing 201 when the force-generating motive surface 232 is not moving. In the illustrated embodiment, movement of the upper separation point 284′ aft and deflection of the turbulent wake 285′ downward shifts the resultant force vector R′ toward the vertical axis and increases the magnitude of the resultant force vector R′ compared to the resultant force vector R acting on the wing 201 when the force-generating motive surface 232 is not moving (i.e., the magnitude of the resulting force vector R′ is larger than the resulting force vector R and angle α′ is smaller than the angle α). Shifting the direction of the resultant force vector W toward the vertical axis reduces the pressure drag force D′ acting on the wing 201 and increases the lifting force L′ acting on the wing 201. Accordingly, in the illustrated embodiment, the drag force component D′ is smaller than the drag force component D and the lifting force component L′ is greater than the lifting force component L.

FIG. 8C illustrates the aerodynamic properties of the wing 201 and the dynamically controllable force-generating device 200 when both the force-generating motive surface 232 and the controlling motive surfaces 253 are actuated to move (arrows 239, 258) in the direction of the advancing streamlines 280. As illustrated in FIG. 8C, the fluid flow over the upper surface 220 of the skin 219 of the wing 201 is accelerated by the movement (arrows 239, 258) of the force-generating motive surface 232 and the controlling motive surfaces 253 in the direction of the advancing streamlines 280. The movement (arrows 239, 258) of the force-generating motive surface 232 and the controlling motive surfaces 253 also energizes the boundary layer 283 and thereby delays separation of the boundary layer 283 from the upper surface 220 of the skin 219 of the wing 201. Thus, in FIG. 8C, the boundary layer 283 separates at upper separation point 284″, which is aft of the upper separation point 284 in FIG. 8A when the force-generating motive surface 232 is not moving and is aft of the upper separation point 284′ in FIG. 8B when only the force-generating motive surface 232 is moving. That is, the upper separation point 284′ of the boundary layer 283 in FIG. 8B moves aft (i.e., toward the trailing edge 225 of the wing 201) to upper separation point 284″ when both the force-generating motive surface 232 and the controlling motive surfaces 253 are actuated to move (arrow 239, 258) in the direction of the streamlines 280. In the illustrated embodiment, the upper separation point 284″ of the boundary layer 283 is aft the controlling motive surfaces 253 and is proximate the trailing edge 225 of the wing 201. Additionally, the movement of the upper separation point 284″ aft deflects the turbulent wake 285″ downward compared to the turbulent wake 285 in FIG. 8A when the force-generating motive surface 232 is not moving and the turbulent wake 285′ in FIG. 8B when only the force-generating motive surface 232 is moving.

Still referring to FIG. 8C, when the force-generating motive surface 232 and the controlling motive surfaces 253 are moving (arrows 239, 258) in the direction of the advancing streamlines 280, the pressure differential across the wing 201 creates a resultant force vector R″ acting on the wing 201 that is deflected aft from the vertical axis by an angle α″. The resultant force vector R″ can be resolved into a drag force component D″ and a lifting force component L″. Due to the movement of the upper separation point 284″ aft and the deflection of the turbulent wake downward 285″, the resultant force vector R″ acting on the wing 201 has a different magnitude and sense than the resultant force vector R (see FIG. 8A) acting on the wing 201 when neither the force-generating motive surface 232 nor the controlling motive surfaces 253 are moving and a different magnitude and sense than the resultant force vector R′ acting on the wing 201 when only the force-generating motive surface 232 is moving. In the illustrated embodiment, movement of the upper separation point 284″ aft and deflection of the turbulent wake 285″ downward shifts the resultant force vector R″ toward the vertical axis and increases the magnitude of the resultant force vector R″ compared to the resultant force vector R′ acting on the wing 201 when only the force-generating motive surface 232 is moving (i.e., the magnitude of the resulting force vector R″ is larger than the resulting force vector R′ and angle α″ is smaller than the angle α′). Shifting the direction of the resultant force vector R″ toward the vertical axis reduces the pressure drag force D″ acting on the wing 201 and increases the lifting force L″ acting on the wing 201. Accordingly, in the illustrated embodiment, the drag force component D″ is smaller than the drag force component D′ and the lifting force component L″ is greater than the lifting force component L′.

FIG. 8D illustrates the aerodynamic properties of the wing 201 and the dynamically controllable force-generating device 200 when both the force-generating motive surface 232 and the controlling motive surfaces 253 are actuated to move (arrows 239, 258) in the direction of the advancing streamlines 280 and the inboard and outboard shroud assemblies 205, 206 are actuated (arrow 269) such that the shrouds 265 are in a deployed position and cover a portion of the respective controlling motive surfaces 253. As described above, deploying the shrouds 265 reduces the effective exposed areas 259 of the controlling motive surfaces 253 and increases the effective distance between the force-generating motive surface 232 and the controlling motive surfaces 253. Accordingly, deploying the shrouds 265 reduces the effect of the controlling motive surfaces 253 on the force-generating motive surface 232. Thus, in FIG. 8D, the boundary layer 283 separates at upper separation point 284′″, which is forward of the upper separation point 284″ in FIG. 8C when the force-generating motive surface 232 and the controlling motive surfaces 253 are moving but the shrouds 265 are not deployed. That is, the upper separation point 284″ of the boundary layer 283 in FIG. 8C moves forward (i.e., toward the leading edge 223 of the wing 201) to upper separation point 284′″ when the shrouds 265 are actuated into a deployed position. Additionally, the movement of the upper separation point 284′″ forward deflects the turbulent wake 285′″ upward compared to the turbulent wake 285″ in FIG. 8C when the force-generating motive surface 232 and the controlling motive surfaces 253 are moving but the shrouds 265 are not deployed.

Still referring to FIG. 8D, deploying the shrouds 265 when the force-generating motive surface 232 and the controlling motive surfaces 253 are moving (arrows 239, 258) in the direction of the advancing streamlines 280 shifts the resultant force vector R′″ away from the vertical axis and reduces the magnitude of the resultant force vector R′″ such that the magnitude of the resulting force vector R′″ is smaller than the resulting force vector R′″ and angle α′″ is larger than the angle α″. Shifting the direction of the resultant force vector R′″ away from the vertical axis increases the pressure drag force D′″ acting on the wing 201 and reduces the lifting force L′″ acting on the wing 201. Accordingly, in the illustrated embodiment, the drag force component D′″ is greater than the drag force component D″ and the lifting force component L′″ is less than the lifting force component L″.

Accordingly, the direction and magnitude of the resultant force vector R acting on the wing 201 may be controlled by adjusting the surface speed of the force-generating motive surface 232, adjusting the surface speed of one or more of the controlling motive surfaces 253, and/or by deploying one or more of the shrouds 265 to cover at least a portion of one or more of the controlling motive surfaces 253.

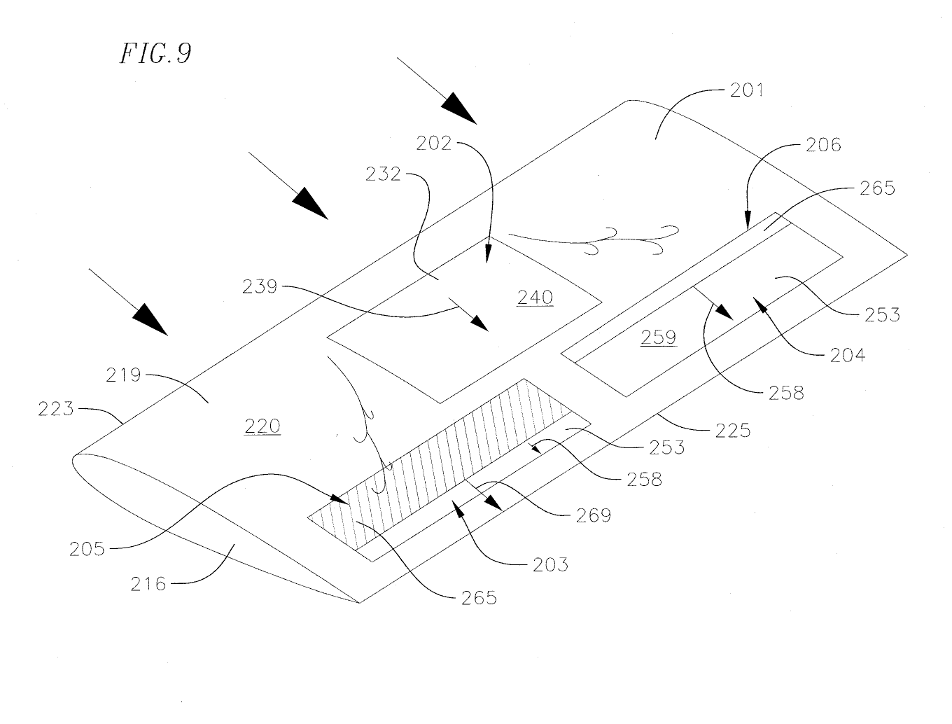

Additionally, as described above, the shrouds 265 of the inboard and outboard shroud assemblies 205, 206 may be independently actuatable. The independent actuatability of the shrouds 265 facilitates creating a lifting force differential between the inboard and outboard controlling assemblies 205, 206. For instance, as illustrated in FIG. 9, the shroud 265 of the inboard shroud assembly 205 may be actuated into a deployed position in which the shroud 265 covers a portion of the controlling motive surface 253 of the inboard controlling assembly 203 and the shroud 265 of the outboard controlling assembly 204 may be actuated into the stowed position (or a deployed position covering less of the exposed area 259 of the controlling motive surface 253 of the outboard controlling assembly 204 than the inboard controlling assembly 203) to create a differential lifting force between the inboard and outboard controlling assemblies 205, 206 (e.g., a greater lifting force proximate the outboard controlling assembly 204 and a lower lifting force proximate the inboard controlling assembly 203). The differential lifting force generated between the inboard and outboard controlling assemblies 205, 206 may be used, for instance, to impart a rolling force to the vehicle or other structure, such as an aircraft, to which the wing 201 is attached.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. The values setforth herein are provided by way of example only and the embodiments of the dynamically controllable force-generating device should not be limited to any particular values recited herein. Instead, it will be appreciated that the values of the various parameters of the dynamically controllable force-generating device (e.g., the sizes and rotation rates of the primary and auxiliary motive bodies or the force-generating and controlling assemblies) will vary depending on the design, scale, and application of the dynamically controllable force-generating device. Although relative terms such as “outer,” “inner,” “upper,” “lower,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it can be directly on the other component or components may also be present therebetween. Moreover, when a component is component is referred to as being “coupled” to another component, it can be directly attached to the other component or intervening components may be present therebetween.

What is claimed is:

1. A dynamically controllable force-generating device, comprising:
a force-generating motive surface;
a motor operatively coupled to the force-generating motive surface to move at least a portion of the force-generating motive surface to generate a force;
at least one controlling motive surface spaced apart from the force-generating motive surface; and
a motor operatively coupled to the at least one controlling motive surface to move at least a portion of the controlling motive surface to change at least one of a direction and a magnitude of the force generated by the force-generating motive surface.

2. The dynamically controllable force-generating device of claim 1, wherein the force-generating motive surface has a first size and the at least one controlling motive surface has a second size different than the first size.

3. The dynamically controllable force-generating device of claim 2, wherein the second size is smaller than the first size.

4. The dynamically controllable force-generating device of claim 1, wherein the force-generating motive surface has a first size and the at least one controlling motive surface has a second size substantially the same as the first size.

5. The dynamically controllable force-generating device of claim 1, wherein the force-generating motive surface has a shape selected from the group of shapes of revolution consisting of a cylinder, a cone, a paraboloid, an ellipsoid, a hyperboloid, and portions thereof.

6. The dynamically controllable force-generating device of claim 3, wherein the controlling motive surface has a shape selected from the group of shapes of revolution consisting of a cylinder, a cone, a paraboloid, an ellipsoid, a hyperboloid, and portions thereof.

7. The dynamically controllable force-generating device of claim 1, wherein only a portion of the force-generating motive surface is configured to move.

8. The dynamically controllable force-generating device of claim 1, wherein only a portion of the at least one controlling motive surface is configured to move.

9. The dynamically controllable force-generating device of claim 1, further comprising a second motor coupled to the at least one controlling motive surface, the second motor configured to move the at least one controlling motive surface between a first position spaced apart from the force-generating motive surface by a first distance and a second position spaced apart from the force-generating motive surface by a second distance different than the first distance.

10. The dynamically controllable force-generating device of claim 1, wherein the at least one controlling motive surface comprises a plurality of controlling motive surfaces proximate the force-generating motive surface.

11. The dynamically controllable force-generating device of claim 10, wherein each of the plurality of controlling motive surfaces is independently actuatable between a first position spaced apart from the force-generating motive surface by a first distance and a second position spaced apart from the force-generating motive surface by a second distance different than the first distance.

12. The dynamically controllable force-generating device of claim 1, further comprising a second motor coupled to the at least one controlling motive surface, the second motor configured to move the at least one controlling motive surface around the force-generating motive surface between a first position and a second position different than the first position.

13. The dynamically controllable force-generating device of claim 1, further comprising an endplate assembly coupled to a first end of each of the force-generating motive surface and the at least one controlling motive surface.

14. The dynamically controllable force-generating device of claim 13, wherein the endplate assembly defines at least one track slidably supporting the first end of the at least one controlling motive surface.

15. The dynamically controllable force-generating device of claim 1, wherein the at least one controlling motive surface is configured to move laterally along an axis defined by the at least one controlling motive surface.

16. The dynamically controllable force-generating device of claim 1, further comprising a shroud disposed between the force-generating motive surface and the at least one controlling motive surface, wherein the shroud is configured to move between a retracted position and a deployed position.

17. The dynamically controllable force-generating device of claim 1, wherein the force-generating motive surface and the at least one controlling motive surface are coupled to a wing or a rotor hub.

18. A method of dynamically altering fluid dynamic properties of a force-generating device comprising a force-generating motive surface and at least one controlling motive surface spaced apart from the force-generating motive surface, the method comprising:
introducing the force-generating device into a fluid flow having a free-stream velocity;
moving at least a portion of the force-generating motive surface at a first surface speed; and
changing the at least one controlling motive surface from a first state to a second state, wherein:
the force-generating motive surface generates a first resultant force having a first direction and a first magnitude when the controlling motive surface is in the first state,
the force-generating motive surface generates a second resultant force having a second direction and a second magnitude when the controlling motive surface is in the second state, and
at least one of the second direction and the second magnitude is different than a corresponding one of the first direction and the first magnitude.

19. The method of claim 18, wherein changing the at least one controlling motive surface from the first state to the second state comprises moving the controlling motive surface from a first position spaced apart from the force-generating motive surface by a first distance to a second position spaced apart from the force-generating motive surface by a second distance different than the first distance.

20. The method of claim 19, wherein the second position alters a boundary layer formed around the force-generating motive surface by a first extent and the first position alters the boundary layer by a second extent different than the first extent.

21. The method of claim 18, wherein changing the at least one controlling motive surface from the first state to the second state comprises accelerating or decelerating the at least one controlling motive surface from a first surface speed to a second surface speed different than the first surface speed.

22. The method of claim 18, wherein changing the at least one controlling motive surface from the first state to the second state comprises moving the at least one controlling motive surface around the force-generating motive surface from a first angular position to a second angular position.

23. The method of claim 18, wherein changing the at least one controlling motive surface from the first state to the second state comprises moving a shroud between a retracted position and a deployed position.

24. The method of claim 18, further comprising accelerating or decelerating the force-generating motive surface to a second surface speed different than the first surface speed.

25. The method of claim 18, further comprising moving the at least one controlling motive surface laterally along an axis of the at least one controlling motive surface.

26. The method of claim 18, wherein the force-generating motive surface and the at least one controlling motive surface are coupled to a wing or a rotor blade.

27. A dynamically controllable force-generating device, comprising:
a first motive surface having a first size;
a motor operatively coupled to the first motive surface to move at leak a portion of the first motive surface at a first surface speed;
a second motive surface spaced laterally from the first motive surface, the second motive surface having a second size; and
a motor operatively coupled to the second motive surface to move at least a portion of the second motive surface at a second surface speed,
wherein one of the first motive surface and the second motive surface is configured to generate a force, and
wherein the other of the first motive surface and the second motive surface is configured to change at least one of a direction and a magnitude of the force generated by the one of the first motive surface and the second motive surface.

28. The dynamically controllable force-generating device of claim 27, wherein the first and second motive surfaces are side-by-side.

29. The dynamically controllable force-generating device of claim 27, wherein the first and second motive surfaces are staggered.

30. The dynamically controllable force-generating device of claim 27, wherein, when at least one of the first surface speed and the first size is greater than a respective one of the second surface speed and the second size, the first motive surface is a force-generating motive surface generating the force, and the second motive surface is a controlling motive surface configured to change the at least one of the direction and the magnitude of the force generated by the force-generating motive surface.

31. The dynamically controllable force-generating device of claim 27, wherein, when at least one of the first surface speed and the first size is less than a respective one of the second surface speed and the second size, the second motive surface is a force-generating motive surface generating the force, and the first motive surface is a controlling motive surface configured to change the at least one of the direction and the magnitude of the force generated by the force-generating motive surface.
